(19) United States
(12) Patent Application Publication
(10) Pub. No.: US 2020/0088202 A1
(43) Pub. Date: Mar. 19, 2020

(54) Integrated MVDC Electric Hydraulic Fracturing Systems and Methods for Control and Machine Health Management

(71) Applicants: Axel Michael Sigmar, Lago Vista, TX (US); Leland Modoc, Lago Vista, TX (US)

(72) Inventors: Axel Michael Sigmar, Lago Vista, TX (US); Leland Modoc, Lago Vista, TX (US)

(21) Appl. No.: 16/397,145

(22) Filed: Apr. 29, 2019

Related U.S. Application Data
(60) Provisional application No. 62/663,947, filed on Apr. 27, 2018.

(51) Int. Cl. F04D 15/00; G05B 13/02; F04D 13/06

(52) U.S. Cl. CPC F04D 15/00; F04D 13/06; G05B 13/021

(57) ABSTRACT

An integrated fracking system may include one or more fuel systems, one or more power generation systems, one or more low-pressure fluid mixture feed units, one or more pumping units, and a control system. The control system may include a computing system accessible by an operator to manage one or more operating parameters and may include a plurality of distributed control elements. In some implementations, the integrated fracking system may include a comprehensive control system, which may include the computing system and the distributed control elements to provide integration of one or more stages of delivery of fracturing solids and fluids to the well. The comprehensive control system may include sensors, control logic, and other components, which may be distributed through various elements of the fracking system and which may be configured to independently and, in conjunction with other components, manage the health of the system.

### CROSS-REFERENCE TO RELATED APPLICATION(S)

This application is a non-provisional of and claims priority to U.S. Provisional Patent Application No. 62/663,947 filed on Apr. 27, 2018 and entitled “Integrated MVDC Electric Hydraulic Fracturing Systems and Methods for Control and Machine Health Management,” which is incorporated herein by reference in its entirety.

### FIELD

The present disclosure is generally related to hydraulic fracturing systems and methods, and more particularly to integrated medium voltage direct current hydraulic fracturing systems and methods for control and machine health management.

### BACKGROUND

Conventional hydraulic fracturing (or fracking) utilizes the force of hydraulic pressure in combination with various chemical suspensions and proppants to break apart or fracture strategic rock formations deep underground via previously drilled access points known as wells. The breaking of these formations releases otherwise inaccessible pockets of various hydrocarbon fluids, which can be collected, separated, and refined into commercially viable products. The commercial viability of the final products is greatly impacted by the operating cost of the fracturing process, which is generally regarded as the largest expense in the chain of production.

Considerable technological and engineering advancements in the geotechnical, geospatial, seismic, and well-planning domains have created expansive predictable well designs that demand increasing levels of power and precision. Managing the onsite mixing and distribution of the various chemical suspensions and proppants at the exacting ratios, flow rates, and pressures may require a large, highly technical skilled labor force, which may be supported by extensive maintenance and logistics resources that come at considerable expense.

In general, there is tremendous economic pressure on containing the cost of the well completion operations, in particular hydraulic fracturing pressure pumping service operations and related considerations. Additionally, there are other factors that can affect the cost of wells, and access to the land and subsequently the subsurface hydrocarbons, such as social and environmental factors, including heavy truck traffic, the size of the pad containing a number of wellheads, noise of operations and increasing regulation limiting exhaust emissions, and other factors.

### SUMMARY

Embodiments of integrated fracking systems and methods are described below that may include one or more fuel systems, one or more power generation systems, one or more low-pressure fluid mixture feed units, one or more integrated pumping units, all of which may be controlled via a plurality of distributed control elements and via a control system. In some implementations, the integrated fracking system may include a comprehensive control system, which may integrate all stages of delivery of fracturing solids and fluids to the well, including generating the precise power that is necessary to achieve the delivery efficiently.

While conventional frack fleets have a control cabin that monitors and operates the various pieces of equipment that comprise the fleet, generally by throttle and transmission control of many diesel engines, the integrated fracking system may control the electric power being generated in response to the fluid output pressure commanded and based on a prediction of the power the pumps may need to provide the flow required to sustain that pressure. In one implementation, the electric power may be controlled by varying the turbine speed rather than varying the turbine fuel rate to maintain a selected RPM and frequency. The integrated control system, enabled by distributed control, machine health management, and the system architecture, may allow for higher transient power when needed. For example, the comprehensive control system may include sensors, control logic, and other components, which may be distributed through various elements of the fracking system and which may be configured to independently (and provide machine health management in conjunction with other elements of the fracking system.

The integrated MVDC electric hydraulic fracturing system may be compact, high power, efficient, reliable and low maintenance, and may require less manpower to mobilize, rig up and rig down than conventional systems. Further, the integrated fracturing system may have a reduced size and cost of the maintenance organization required to sustain high availability in extreme service, as compared to a conventional system composed of many large diesel engines, transmissions, reduction gears and individual power-end/fluid-end pumps. Moreover, the integrated fracturing system may provide reduced noise, reduced emissions, reduced traffic, and enhanced safety, as compared to conventional systems. Consequently, the integrated fracturing system may provide a significant reduction in the cost of pressure pumping service and associated factors which improve the well economics, and may provide a decisive competitive advantage to the pressure pumping service provider.

Embodiments of an integrated electric hydraulic fracturing system are described below that may include one or more gas turbine-powered generators or alternators configured to supply medium voltage direct current (MVDC) power. The system may further include one or more integrated pump systems coupled to the power supply and configured to receive low pressure, high volume fluid and to deliver the fluid at high pressure to a well through a high flow-high pressure fluid delivery system. Additionally, the system can include a distributed control system including a plurality of processing circuits associated with connectors between the MVDC power supply and the integrated pumps, within each motor of these pumps, and within the pumps themselves. In some implementations, the system may include a plurality of sensors and monitoring systems, including well-monitoring systems, which may be integrated into a feedback loop or feed forward loop to provide enhanced efficiency and performance. Other embodiments are also possible.

In some embodiments, the integrated electric hydraulic fracturing system may represent a major improvement in hydraulic horsepower (HHP) output, performance, and cost reduction as compared to conventional diesel-powered systems. The integrated electric hydraulic fracturing system may also represent an improvement over the few systems powered directly with transmissions and reduction gears by (small) gas turbines or by larger turbine alternating current (AC) generator power sources, which can be significantly more expensive to acquire and mobilize, may be significantly more complex, and may be extremely heavy, although they sometimes claim a reduced total cost of ownership. Using a plurality of integrated pump systems may enable an ultra-high density hydraulic fracturing system solution. The use of MVDC power generation, distribution, control, and health management enables the capital cost of generating the power to be approximately the same as the diesel engine powered pump units that are replaced, while significantly reducing the total cost of ownership, increasing the capability to meet the demands of more intensive completion designs, while reducing traffic, noise, emissions, pad size, the size and cost of the maintenance organization required, and increasing availability and utilization of the equipment.

In some embodiments, a fracking system may include a turbine power unit, a fuel system, one or more low pressure feed units, a high-pressure feed, one or more pumping units, and a distributed control system. The turbine power unit may be configured to generate direct current, or an alternating current, which may be converted to medium voltage direct current (MVDC), which serves as the primary power supply to the pumping and delivery system. In some implementations, the turbine power unit may include an alternator with integral rectification to provide MVDC directly. In some implementations, an auxiliary low voltage AC power source may be integrated with the MVDC power distribution to power the system instrumentation and controls, and secondary loads, which may include smaller pumps, other actuators, and associated instrumentation. Such controls and secondary loads may be included in the low pressure feed system, the control cabin computers, lights and air conditioners, and other smaller loads while the main power for pumping is distributed as MVDC.

The fuel system may be configured to deliver fuel to the turbine power unit. The one or more low pressure feed units may be configured to deliver a fracking fluid to a low-pressure intake or manifold. Each integrated pumping unit may include an input coupled to a low pressure intake, a plurality of motors, and a plurality of pistons. The plurality of pistons may be configured to receive the fracking fluid at low pressure and to deliver the fracking fluid at high pressure to a high pressure outlet manifold. The high pressure outlet manifold may be coupled to a plurality of high pressure outlet manifolds of the one or more pumping units. The distributed control system may include a plurality of processing circuits incorporated within each of the turbine power unit, the fuel system, the one or more low pressure feed units, and the one or more pumping units. In some implementations, the system may include well head sensors and sensors associated with the high pressure output of the pumping units, which may be used to predict when rock within the well is near a fracture pressure. This prediction information may be used to adjust other components of the overall system in advance of changes in the operation of the motors and pumps, providing enhanced feedback, distributed control and active machine health managements of various subsystems and their components for the generation and use of the electric and fluid power, enabling higher efficiency across a wider range of power levels, higher peak power levels when necessary, higher reliability, and longer life with less maintenance, reduced capital, operational and fuel costs, reduced emissions, reduced noise, reduced pad size, reduced traffic, and so on. The various enhancements, individually and in combination, may improve the well economics for the energy companies and also provide competitive advantages for the service providers.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of an integrated electric hydraulic fracturing system, in accordance with certain embodiments of the present disclosure.

FIG. 2A depicts a block diagram of a power generation portion of the integrated electric hydraulic fracturing system of FIG. 1, in accordance with certain embodiments of the present disclosure.

FIG. 2B depicts a block diagram of a pumping portion of the integrated electric hydraulic fracturing system of FIG. 1, in accordance with certain embodiments of the present disclosure.

FIG. 3 depicts a block diagram of a system including a control system and a plurality of distributed control elements, in accordance with certain embodiments of the present disclosure.

FIG. 4 depicts a perspective view of the power generation portion of the integrated electric hydraulic fracturing system of FIGS. 1 and 2, in accordance with certain embodiments of the present disclosure.

FIG. 5 depicts a perspective view of the pumping portion of the integrated electric hydraulic fracturing system of FIGS. 1 through 4, in accordance with certain embodiments of the present disclosure.

FIG. 6 depicts a block diagram of a low-pressure fluid processing and delivery system, in accordance with certain embodiments of the present disclosure.

FIG. 7 depicts a block diagram of the integrated electric hydraulic fracturing system of FIGS. 1-6, in accordance with certain embodiments of the present disclosure.

FIG. 8 depicts a block diagram of a plant representing the integrated electric hydraulic fracturing system of FIGS. 1-7, in accordance with certain embodiments of the present disclosure.

FIG. 9 depicts a block diagram of a control system of the integrated electric hydraulic fracturing system of FIGS. 1-8, in accordance with certain embodiments of the present disclosure.

FIG. 10 depicts a block diagram of the integrated electric hydraulic fracturing system of FIGS. 1-9 and including a system controller, in accordance with certain embodiments of the present disclosure.

While implementations are described in this disclosure by way of example, those skilled in the art will recognize that the implementations are not limited to the examples or figures described. It should be understood that the figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of an integrated electric hydraulic fracturing system may include a control architecture, sensors, and one or more actuators that may provide the ability to respond quickly to changing pressures and flows as the formation fractures propagate away from the wellbore. Further, the integrated electric hydraulic fracturing system may have the capacity to maintain the desired pressure and flow for a longer stage or a larger radius with the same or improved geo-mechanical effect to access and drain the hydrocarbons by hydraulic fracturing. Additionally, the integrated electric hydraulic fracturing system may utilize casing and tubing sizes that ease access for inserting and removing plugs between the stages, especially in longer wells with increased production and reduced cost. Moreover, integrated electric hydraulic fracturing system may utilize enhanced connections and longer tubing sections, reducing pressure losses at high flow rates. The complexity, vulnerability, risk to personnel, and pressure drop in the surface high pressure delivery system are significantly reduced in the compact nature of these embodiments of an integrated electric hydraulic fracturing system.

In one possible implementation, the system may include a plurality of subsystems, each of which may include a plurality of components and one or more control elements. The control elements may operate autonomously to manage operation of the plurality of components within safe operating ranges, to detect anomalies, and to prevent damage to the components. Further, the system may include a control system coupled to each of the plurality of control elements. The control system may receive signals from the control elements and may determine operating parameters associated with the various subsystems and components based on the received signals. Further, the control system may be configured to predict a change in demand or a change in attributes of one or more of the subsystems based on the signals. The control system may send control signals to one or more of the control elements to alter operation of one or more subsystems according to a pre-determined schedule in response to predicting the change. Other implementations are also possible.

Embodiments of an integrated electric hydraulic fracturing system may include one or more rotating electric machines (generators) coupled to a rotating mechanical machine with a controlled fuel delivery system, all configured to supply a wide range of MVDC power efficiently. The system may further include one or more low-pressure feed units configured to provide a low pressure, high volume supply of fluid. The system may further include a plurality of pump systems, each of which may include one or more motors and a plurality of pump elements, such as a plurality of piston blocks and corresponding fluid ends. The pump systems may include a plurality of fluid intakes coupled to the one or more low-pressure feed units and may include a plurality of fluid outlets coupled to a high pressure feed, which may be configured to deliver the high pressure fluid into a well. Sensors are incorporated in various places and utilized in the control of these systems which comprise the integrated electric hydraulic fracturing system, which may include the well and the execution of the stages of the hydraulic fracturing operations design to complete the well and produce the hydrocarbons to be liberated after the rock is fractured.

Gas turbine alternating-current (AC) power generation systems, in very limited use for hydraulic fracturing, are significantly more complex, and incredibly heavy. Each node must further be synchronized with or fully segmented from all other ac power in the system. At the implemented voltage and power levels, considerable shielding for noise and protective insulations must be utilized.

In some embodiments, the integrated electric hydraulic fracturing system may include a plurality of processing circuits (sometimes called electronic control devices (ECD)). Each ECD may include a memory to store data and a plurality of processor-executable instructions and may include a processor to perform one or more operations based on the instructions. In an example, one or more of the ECDs may be configured to measure a parameter, to evaluate the measured parameter, and to act on the measured parameter in light of a selected operating state. The ECDs may be configured to communicate with one another and with other controllers throughout the system. Algorithms, states, and system response tables may be modified by the distributed ECDs based on their communications on various levels, while responding to central commands and honoring limits which may be set centrally or allowed to be modified locally to protect the components, prolong their life, maximize efficiency, or maximize peak power transients commanded centrally or required by the distributed, integrated control system.

In some implementations, the integrated electric hydraulic fracturing system may include an operator control system accessible by a user or operator and configured to communicate control signals to one or more of the ECDs and to control overall operation of the system, for example, to override local controls and to define the operating state of the system. Each ECD may operate in conjunction with one or more other ECDs to balance loads across one or more systems, one or more devices, or portions of a device. For example, one or more ECDs may cooperate to shift a load between groups of coils within a stator (across portions of a device), between stators of one or more motors (across devices), or from the groups of coils in a stator to an associated cooling system (across systems), or any combination thereof.

The thermal load in the above-example is the heat generated in the coil assembly of the electric motor. The generated heat must be transferred out in order to keep the temperature from rising to a critical limit, which may be observable by virtue of the distributed control. The actual load is the work being done in the coil assembly, that may be shifted to other coil assemblies within the same motor or to coil assemblies of another motor, as the local controller (and optionally as distributed control elements) determines the local reserve capacity is diminishing, compared to the others with which it is communicating. Similarly a cooling subsystem may be able to receive heat carried by the cooling dielectric fluid in accordance with its capacity to dissipate that heat into the atmosphere, thus establishing another reserve capacity metric. The reserve capacities may be balanced (and sometimes optimized) between the controllers, adjusted in accordance with their abilities and, before critical limits are violated, the local controller (and optionally the distributed control elements) may limit the heat being generated in the coil assemblies as it does the primary work desired.

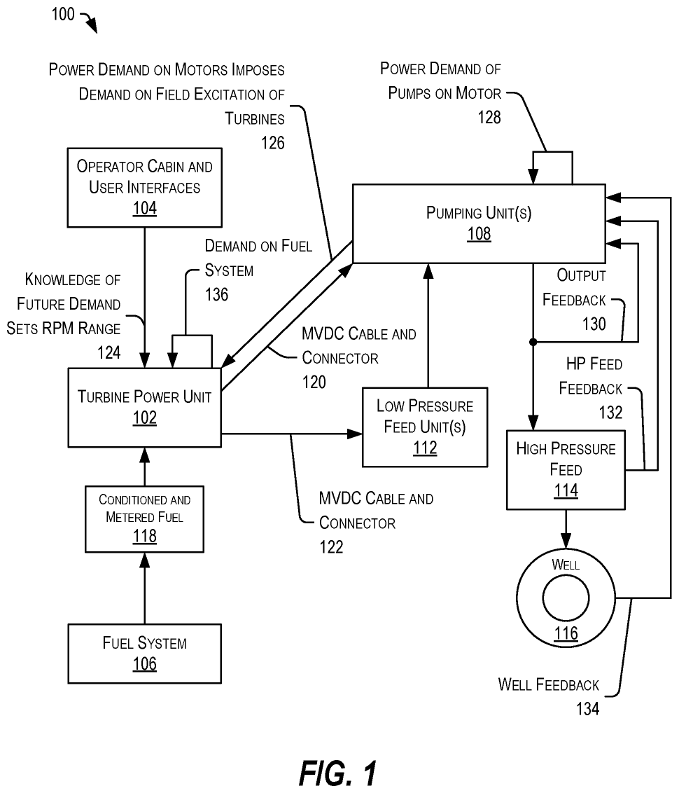

If load cannot be shifted and all reserve capacities are fully utilized, then the limit of peak performance has been fully reached. Operator intervention could increase limits to gain more performance, which will shorten the overall life of the machine. However, the system may perform longer than conventional machines without distributed control and machine health management because any one device, without such local control would have exceeded it limit and failed sooner. Moreover, distributed control and machine health management may utilize all parts that comprise the system in parallel, rather than a series chain which may fail with the weakest link. The distributed control and machine health management features may fundamentally and favorably alter mean time between failures in complex systems. One possible example of an integrated electric hydraulic fracturing system is described below with respect to FIG. 1.

FIG. 1 depicts a block diagram of an integrated electric hydraulic fracturing system 100, in accordance with certain embodiments of the present disclosure. The system 100 may include a turbine power unit 102 communicatively coupled to an operator cabin and user interfaces 104, which may be configured to control operation of the turbine power unit 102. The system 100 may further include a fuel system 106 configured to deliver conditioned and metered fuel 118 to the turbine power unit 106.

The turbine power unit 102 may be configured to deliver MVDC power via an MVDC cable and connector 120 to the pumping units 108, which may include one or more motors and an a plurality of pump components including a plurality of piston blocks. The turbine power unit 102 may also deliver MVDC power via an MVDC cable and connector 122 to one or more low-pressure feed units 112. The pumping units 108 may be configured to receive fluid from the one or more low-pressure feed units 112 and may be configured to deliver the fluid under high pressure to a high pressure feed 114, which may be coupled to a well 116.

In a certain embodiment, the turbine power unit 102 may include one or more gas turbine powered generators or alternators, typically running at variable speeds selected to enable an efficient rotational speed and corresponding fuel rate for a particular turbine given the power requirements and operating conditions of the system 100. Power produced by the generators may be rectified to produce the MVDC power supply efficiently at the power level required, at a voltage level that may be controlled by varying the field excitation of the generator or alternator, independent of the speed of rotation, enhancing the efficiency of the rotating mechanical machine at the required or predicted power level. The one or more gas turbine powered generators or alternators may be provided in a single transportable unit at power levels exceeding 30 MW, because of the combination of oil-cooled power electronics, composite materials, and a novel control and machine health management system, which may be distributed across a plurality of components. While it is well known that increasing frequency substantially reduces the size of the magnetic components used to produce the power, embodiments of the present disclosure may dynamically manage power production across a range of power levels and in a variety of conditions in a portable, robust, and efficient architecture. Control of the use and the supply of the power efficiently across a wide range is enabled in an integrated system, without mechanical transmissions, reduction gears, inefficient bypass of excess compressed intake air and other factors which raise the cost and reduce the reliability and availability of other conventional hydraulic fracturing systems.

In the illustrated example, the pumping units 108 may receive pressure, flow rate, and temperature parameters from the well 116, high pressure delivery system feedback 132 from the HP feed 114, and pump output feedback 130 from fluid ends of the pumping units 108. Further, the pumping units 108 may include power demand feedback 128 from its motors. The power demand on the motors produces feedback 126 representing demand on field excitation of the turbines, which feedback 126 is provided to the turbine power unit 102. The turbine power unit 102 may further include feedback 136 of the demand on the fuel system 106. Other implementations are also possible.

The integrated electric hydraulic fracturing system 100 may include multiple nested feedback loops. The system 100 may provide rapid identification and response to downhole or wellhead pressure due to changes in dynamic flow conditions. The system 100 may receive multiple sensor signals and may respond rapidly to such signals to enable rapid system response, improved performance, and so on. The system 100 may require less excess power or over-specification of the power specification because peak power demands can be handled with reserve capacity or incremental enhancement for local conditions, such as cooling system limitations, among others.

The motors of the pumping units 108 may directly drive the pump elements (such as pistons) to rapidly change torque and resulting speed based on demand variations. The motor response may also mitigate pump capacity changes in the event that individual cylinders or banks of cylinders may be unloaded due to faults or impending failure, as determined by the distributed fault management system. Very high instantaneous and transient peaks can be limited by the distributed machine health management of each component. Knowledge of thermal inertia and cooling system response may enable accurate prediction of reserve capacity. Rapid response by the power generation system (e.g., turbine power unit 102) may enable rapid motor response and application of peak capacity, while the turbine and fuel system may be adjusted for efficiency at the current and anticipated power levels.

Life estimation, maintenance requirements and planning may also be incorporated into the machine health management system. User overrides which shorten the life but allow continued operation at peak capacity are further incorporated in the machine health management system and method. Continued operation in the event of significant failure or damage by disabling, disconnecting, or bypassing components of the system 100 can utilize successive layers of fault management and cost-performance function optimization, while providing observability and operator intervention the operation and performance parameters of sub-systems and components. Remaining reserve capacity estimates and bottlenecks, which can limit system capacity, may be identified and prioritized for repair, maintenance, or other intervention.

In some implementations, the system 100 may include machine health management as part of the operator cabin and user interfaces 104 and distributed within the turbine power unit 102, the fuel system 106, the pumping units 108, and the low-pressure feed units 112. In some implementations, the operator cabin and user interfaces 104 may continuously assess reserve capacity of the system 100, balance loads across redundant elements, dynamically change between efficiency considerations and performance considerations, and manage energy for startup and shut down, including faults and emergency shut down. In some implementations, the operator cabin and user interfaces 104 may include a health management system that can combine information from distributed health management components with knowledge of the job requirements and user-defined system availability to utilize energy storage in the system (e.g., rotational inertia in the turbine power unit 102 and electrical energy in the DC link capacitors or other electrical storage).

It should be appreciated that well completion is a complex and costly process. The system 100 may be configured to enhance production, enhance efficiency, reduce overall costs, and mitigate undesirable considerations or consequences.

In some implementations, hydraulic fracturing and stimulation methods may be used to complete certain well structures designed to release hydrocarbon trapped in shale formations surrounding a number of such wells. These types of wells are typically considered short-cycle investments, in part, because the significant initial production (approximately 1000 barrels of oil equivalent (“boe”) per day) may be relatively short lived (such as, for example, 1-2 years), followed by a longer period (such as, for example, (10-20 years) of reduced production (<100 boe per day, which may further decline to approximately 10 boe per day). The total amount of hydrocarbon produced may be estimated for economic valuation and may be referred to as Estimated Ultimate Recovery (“EUR”). These wells are completed by hydraulic fracturing (“fracking”). Huge volumes of rock (shale) must be fractured to release the hydrocarbon that is otherwise remains trapped in the rock. Typically, tens of thousands of very similar wells may be drilled and completed to exploit this resource.

The economic viability of such unconventional wells is determined by the cost of drilling, completing, and producing, including the cost of transportation and emissions, land rights and access, and the cost and availability of the enormous amounts of capital required. The geopolitical nature of the oil industry results in rapid, large variations in the price realized for the hydrocarbon produced. Thus, the marginal comparative economics of unconventional wells may determine the amount of capital available. Energy security and prosperity are matters of such global, economic and historical importance that they are difficult to comprehend or overstate. The amount of hydrocarbon available by completing such unconventional wells has shifted the paradigm from fundamental scarcity and increasing prices of “peak oil” to marginal economics and national or geographical considerations including proximity to refining, distribution, and markets. Reducing the marginal cost and impact of producing unconventional hydrocarbons may be of vital economic, national, humanitarian, and environmental importance.

While burning of conventional or unconventional hydrocarbons for transportation and power generation exacerbates carbon emissions, embodiments of the integrated electric hydraulic fracturing system 100 may significantly reduce the environmental impact of unconventional hydrocarbon production in a number of ways, while improving the marginal economics. For example, the turbine power unit 102 may utilize field gas from the well 116 to generate power, which may provide a significant reduction of greenhouse and carbon emissions as compared to power generation systems used in conjunction with conventional fracking systems, which burn diesel or other refined fuels while field gas is being flared in the vicinity. In particular, the integrated electric hydraulic fracturing system 100 for power generation in the producing fields or near pipelines may enable the integration of greater amounts of alternative energy into the electric power distribution network often referred to as the “grid” because of the “stiff” output and the ability to manage phase and power factors. Further, the integrated electric hydraulic fracturing system 100 enables continuous improvements based on repeatability, observability, and controllability, allowing for factory-type improvement methods to be applied to the costly, complex, well-completion process. In fracking, the “factory” must be portable, flexible, and reliable in adverse conditions.

Fracking operations require the generation and use of enormous amounts of energy onsite. Further, the onsite energy usage may be intermittent. For example, in some implementations, the amount of energy that is used by approximately 10,000 homes may be generated and used (switched on and switched off) hourly, on each frack fleet deployment. Currently, hundreds of such frack fleets are deployed in the United States and more worldwide. The flexibility and mobility of the power generated efficiently in the integrated electric hydraulic fracturing system can be adapted and interfaced to the grid, in certain embodiments.

In some implementations, the integrated electric hydraulic fracturing system 100 may also provide distributed power generation, by converting wasteful “flaring” of gas into electricity in a manner that enhances the stability of local power distribution and the power grid. This may enable incorporation of additional alternative energy generated by solar and wind. Other applications may include improving the economics and viability of wind turbines, ship propulsion and power generation, water desalinization, fire suppression, tunnel boring, and other energy intensive activities in remote locations.

In some implementations, the integrated electric hydraulic fracturing system 100 may enables control and optimization of both the generation and the use of power, particularly in large local applications. Further, the integrated electric hydraulic fracturing system 100 may also reliably contribute to larger distributed energy or resource systems. While the integrated electric hydraulic fracturing system 100 is described with respect surface equipment used in hydraulic fracturing, the system 100 may be used in other applications as well.

In one possible implementation, the integrated electric hydraulic fracturing system 100 includes a variable load (the well 114, which is fractured in many stages). The integrated electric hydraulic fracturing system 100 is comprised of a set of pumps (pumping units 108), which may be fed by a fluid blending and recovery sub-system (low-pressure feed units 112). Further, the pumping units 108 and the low-pressure feed units 112 may be powered by a power generating system (turbine power unit 102), which may be fed by a fuel conditioning sub-system (fuel system 106)), and controlled by a command system (which may be part of the operator cabin and user interfaces 104). The command system may determine an intended pressure and volume profile and may manage the progress of the fractures of the well 116 to determine when the pumping operation tapers off and is terminated. In one possible example, the command system may monitor various parameters of each of the components using a simple or sophisticated frack monitoring sub-system. The control of this system reaches across the parts, taking into account the available capacity and different response times of different parts of the system.

In some implementations, the integrated electric hydraulic fracturing system 100 may incorporate distributed machine health management components in each part and associated sub-systems. Distributed machine health management may continuously assess the capacity available in each component of the system observed by the distributed controller. Further, the distributed machine health management elements may communicate to other redundant parts and the overall system, and may utilize a hierarchy of cost functions and algorithms to optimize the efficiency, transient peak performance, deployed reliability, and life of each component, sub-system, and the overall integrated system.

In distributed machine health management, efficiencies of the system 100 may be continually adjusted in accordance with the multivariate distributed cost function hierarchy, while permitting rapid shifts to peak performance modes for transient or sustained operations, without inducing failure and without shortening the life of certain components. Fault management and compensation for external perturbations provides additional stability and reliability for the system 100. Further, the distributed machine health management may improve the response of the intended output to differences in what is commanded, and may increase the transient maximum capacity of the system.

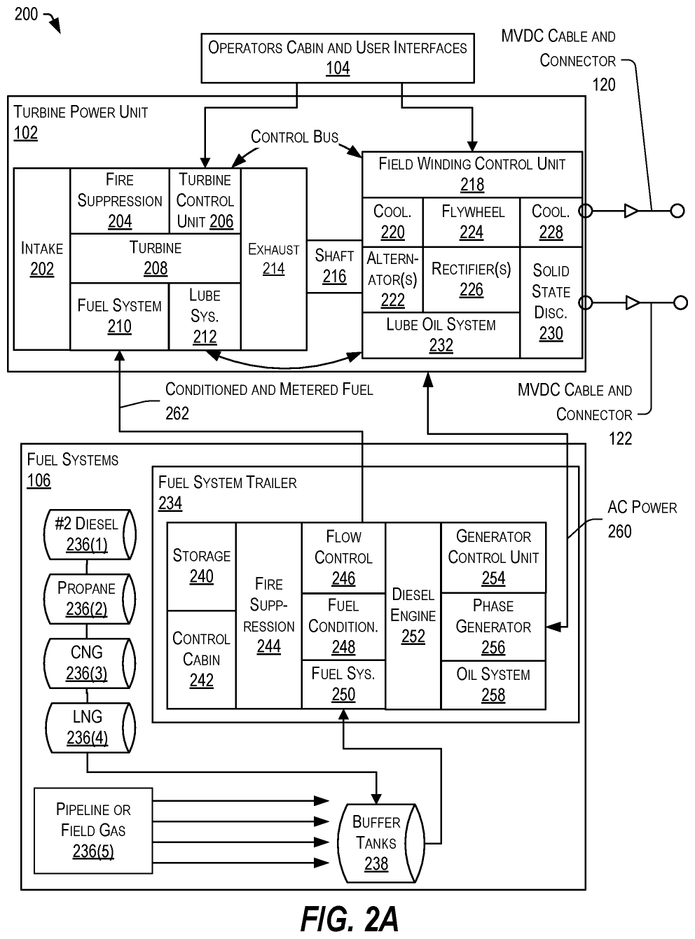

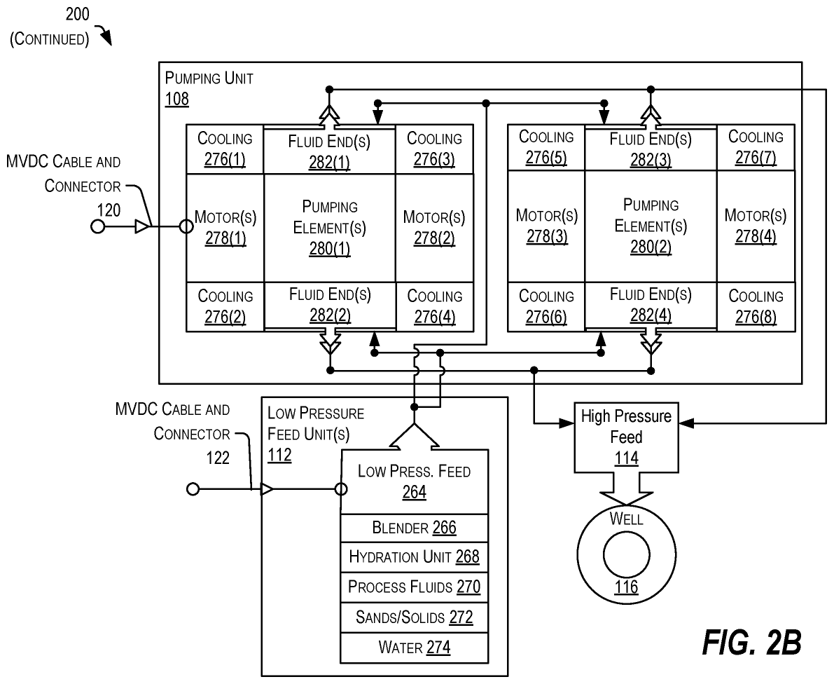

FIG. 2 depicts a block diagram of a power generation portion 200 of the integrated electric hydraulic fracturing system 100 of FIG. 1, in accordance with certain embodiments of the present disclosure. The power generation portion 200 may include the turbine power unit 102, the fuel system 106, and the operators cabin and user interface 104, which may be coupled to the turbine power unit 102.

The turbine power unit 102 may include an intake 202, a fuel system 210, a turbine 208 (such as, for example, an Aero Derivative Turbine (25-35 MW) with 35-43% Chemical Efficiency), and an exhaust 214. The turbine power unit 102 may further include a fire suppression component 204 and a turbine control unit 206, which may be coupled to the operators cabin and user interface 104. Further, the turbine power unit 102 may include a lube oil system 212.

The turbine 208 may be coupled to a shaft 216, which may be coupled to an alternator 222 and to a high inertia flywheel 224. Further, the turbine control unit 206 may be coupled to the field winding control unit 218 by a control bus. The field winding control unit 218 may be coupled to the alternator 222. Further, cooling elements 220 may be provided to cool the windings of the alternator 222. Further, the field winding control unit 218 may include one or more rectifiers 226 and a solid-state disconnect circuit 230. The turbine power unit 102 may include a plurality of outputs 120 and 122 to provide the MVDC power supply to other components. Further, the turbine power unit 102 may include additional cooling elements, such as cooling element 228 and lube oil system 232.

To overcome a number of challenges associated with MVDC power, the turbine power unit 102 can include solid-state fast disconnect circuitry 230, which may be combined with a power system architecture and control system such that isolation and other requirements are robustly and comprehensively addressed. Moreover, the isolation and other requirements and the MVDC power generation can be achieved in a relatively small and lightweight package as compared to AC synchronous generator and switchgear that might otherwise be necessary. In the illustrated example, the turbine power unit 102 may include multiple generators or alternator units of various sizes and response characteristics, which can be combined (or integrated within the turbine power unit 102) without needing to match frequency, maintain phase, and correct power factor. Many of the known, complex fault conditions and other considerations are eliminated or mitigated so equipment sets are not required, reducing weight and cost substantially. Remaining equipment providing safety functions is implemented in solid state power electronics, immersed in dielectric fluid for insulation, cooling, and improved reliability and survivability in mobile applications and hostile environments.

In some implementations, the turbine power unit 102 may generate usable electricity that is independent of the rotating frequency of the turbine 208. By rectifying or producing direct DC (using rectifiers 226) from the generators (turbine 208, shaft 218, and alternator 222), the turbine 208 does not have to run at some frequency multiple of 60 Hz to produce a usable AC current. Instead, the turbine 208 can run at a desired frequency for the turbine 208. In one possible example, the turbine 208 may rotate at a frequency that represents a balance between fuel efficiency and power generation, which enables the turbine 208 to run efficiently at a wide range of power levels. By managing fields in alternator 222 via the field winding control unit 218, power output may be maintained at a wide range of turbine frequencies. Overall, the independent turbine rotation frequency may enable a large efficiency gain in terms of fuel consumption of a completed well. For example, the fuel consumption of a completed well may be reduced by ten percent or more, producing enormous fuel cost savings. Assuming that the fracking crew may operate for 50 weeks of the year, completing an average of one well per week, a conservative estimate of fuel-consumption cost savings indicates a cost savings of about 5 million dollars per year.

The fuel system 106 may include a pipeline or field gas intake 236 coupled to one or more buffer tanks 238. Further, the buffer tanks 238 may receive any number of fuels 236. For example, the fuels 236 may include diesel fuel 236(1), propane 236(2), compressed natural gas (CNG) 236(3), liquefied natural gas (LNG) 236(4), or any combination thereof. The buffer tanks 238 may provide fuel to a fuel system trailer 234. Various fuels sources may be conditioned or blended to satisfy a wide range of heat rates that the turbine fuel and injector system can accommodate. The requirements on the fuel system is lessened by the independence from constant rotational speed, and a different optimization for fuel efficiency and emissions reduction may be enabled by virtue of this independence, resulting in greater efficiency across a wider range of power levels.

The fuel system trailer 234 may include a control cabin 242 for the fuel and power system, with provision for field maintenance and storage 240. Further, the fuel system trailer 234 may include fire suppression components 244 coupled to a fuel system 250, which may be coupled to the buffer tanks 238. In some implementations, a fire suppression system may also be included in the structure of the turbine power unit 102 and incorporated in the machine health management system to enhance fault management response significantly as compared to conventional systems. The fuel system trailer 234 can also include a fuel conditioning system 248 and a flow control system 246 coupled to a diesel engine 252. The fuel trailer system 234 may also include an oil system 258 for lubrication and cooling, an AC generator 256, and a generator control unit 254. The AC generator may be configured to provide an AC power 260 to the turbine power unit 102. Further, the fuel system trailer 106 may be configured to provide conditioned and metered fuel 262 to the fuel system 210 of the turbine power unit 102. The electric power requirement of the motors may be communicated to the turbine power unit 102, which may rapidly change the output power (supplied to the outputs 120 and 122) by varying the field excitation of the alternators 222, up to their respective balanced or maximum reserve capacities. In the illustrated example, the power distribution is DC, so the power distribution is not limited by the instantaneous rotational speed of the generating system, within wide limits. In certain embodiments, the rotational inertia can be significantly enhanced, providing large peak power response, while managing mean rotational speed within limits.

Response of the fuel system 106 is typically significantly slower than the field excitation response, which can be turned to advantage by keeping the rotation speed within wide limits, utilizing the stored energy of rotational inertia by balancing the peak power reserve capacity desired with the average system efficiency. In the turbine power unit 102, the conventional paradigm of constant speed for constant frequency and matched phase is rendered obsolete. For example, the turbine 208 may be operated at a selected speed, and the field winding control unit 218 may control the field excitation of the alternators 222 to achieve a desired power output. Thus, fuel efficiency can be maintained by operating the turbine 208 at an operating speed that provides a desired efficiency while modulating the field excitation of the alternators 222 to continue to generate a selected output power level. The ability to modulate the field excitation provides for a wide range of power levels. Such variability allows for consistent power production in varying load conditions and intermittent operations, or peak/pulsed power operating conditions.

Power system fault management equipment requirements may be reduced, relative to conventional devices, by including solid state DC quick disconnect 230 and load dumping features, such as over-voltage protection circuits, fault protection circuits, limiter circuits, and so on. Fault currents may be much smaller and the total stored energy to be discharged in various parts of the system may be deliberately managed at the generator and in the DC link capacitors integrated in the motors. AC power may be generated at varying frequencies by solid state switching power electronics known as inverters, including precise management of phase and power factor. Other implementations are also possible.

Distributed control of cooling by immersion in and circulation of circulating oil coolant, which may be a dielectric fluid, is applied throughout the system as part of the machine health management and to enhance thermal regulation and to reduce size and weight of the system. The use of such dielectric cooling oils also enables distributed power electronics close to the electromagnetic coils where the work (conversion of electrical to magnetic to mechanical energy and then fluid power) is done.

In some embodiments, the system 200 may include distributed processing circuits configured to control operation of individual components and to communicate with other processing circuits. The distributed control system may provide commanded fluid power, may respond to perturbations, and adjust one or more the fuel and air mixture of the turbine 208, the field excitation of the alternator 222, and the combination of voltage and current required to provide the fluid power output, while honoring the limits of various sub systems including cooling. In a steady state of operation, the distributed processing circuit may be configured to determine and adjust values across the system to enable higher efficiency at a wider range of power levels than is achievable in conventional AC systems. The turbine power unit 102 may include a conventional AC generator to provide power for the control cabin, lights, low-pressure feed system instrumentation and pumps, and basic controls for the pump systems as well as the turbine generator or alternator controls, and the cooling systems, while the high levels of motive power can be provided by the MVDC power supply.

Protection from fault inducing commands, such as over-speed, or excessive changes in speed or direction may be implemented. Monitoring, alarms, and limited specific response techniques (to certain fault conditions, such as over-temperature, over-voltage, over-pressure and other observable known component limits) are also limited. Distributed, communicated, continuous estimation of reserve capacity and distributed coordination of such resources in their application can provide greater protection to the integrated system, considering the redundancy and differing response times of different parts of the system.

It should be appreciated that the system 200 allows for the use of multiple turbines, with higher turn-down ratios, to be combined to achieve efficiency and very high power, in a compact reliable system. Moreover, operation of the multiple turbines can be readily managed through the operators cabin and user interface 104 and via the distributed control elements within the system 200. Moreover, since the turbines operate to produce DC power, synchronization is not required, making the overall system less complex and more efficient, at least in part since losses due to synchronization are reduced or eliminated and each turbine can run at its own speed. Other embodiments are also possible.

FIG. 2B depicts a continuation of the system 200 including the pumping unit 108, the low-pressure feed unit 112, and the high pressure feed unit 114. The pumping unit 108 may be coupled to the well 116 via a high pressure feed 114.

In some embodiments, the one or more low feed pressure units 112 may include a water supply 274, a sand/solids supply 272, a process fluids supply 270, a hydration unit 268, and a blender 266. The blender 266 may mix the fluids and solids to produce fracking fluid supply, which may be provided to the pumping unit 108 by a low pressure feed 112, which may provide the fracking fluid supply at a pressure of approximately 60 pounds per square inch (PSI) at a rate of 80 barrels per minute (BPM) pressure, in a typical embodiment.

The pumping unit 108 may include a plurality of pumping elements 208, may be driven by a plurality of motors 278. The pumping unit 108 may further include an associated cooling system 276, and a plurality of fluid ends 282. The fluid ends 282 may be configured to receive fracking fluid from the low-pressure feed units 112 and to provide high pressure fluid to the high pressure feed 114. In some embodiments, the high pressure fluid may be delivered to the well via the high pressure feed 114 at pressures of 9,000 pounds per square inch or more.

Each motor 278 may include a direct drive, high torque, low RPM motor with integrated drive electronics. The use of multiple direct drive high torque, low rpm motors 278 with integrated drive electronics may be managed so as to ensure high reliability, low maintenance and long life, at very high-power levels in a challenging, mobile environment. The pumping units 108 may combine composite materials, oil-cooled power electronics, and oil-cooled magnetics to achieve required power levels within transportation limits and at significantly reduced cost compared to conventional turbine generator systems. Further, the use of oil-cooling for electronics and magnetics in generation and distribution and in the motive power devices increases the life cycle of the device, enhances reliability, and improves overall efficiency and performance.

Further, processing circuits may be distributed within each motor 278, within the pump elements 280, and within the fluid ends 282 to monitor operation, to evaluate measured parameters, and to take action, such as by adjusting signals, opening or closing valves, activating or deactivating various components, and so on. The monitoring, control, and management of numerous, different variables through use of distributed controller circuits in a layered system and method enables the turbine, generator or alternator, pumps and fluid feed systems to achieve efficiencies, instantaneous power levels, reliability, and life cycles not achieved in conventional systems.

The system 200 allows use of multiple pump elements 280, each of which may include multiple banks of pistons (quad/quint). The multiple pump systems may be combined on a trailer with a significantly more compact, mechanized high pressure high flow conveyance system (high pressure feed 114) to connect to the wellhead 116. This system 200 can be implemented using conventional, steel high pressure fluid components or can be embodied in a lighter system with larger internal diameter hybrid or composite components including connections and swivels, to minimize flow velocities and accompanying pressure drops and erosion problems. In some embodiments, the high pressure feed 114 may include one or more actuators configured to allow a range of motion that is intuitive to the operator and that can move the high pressure feed 114 into alignment with the well 116 to make the connection.

In some implementations, the connection may be established electronically by combining the behavior of multiple actuators, which in turn may be configured in a novel, electrically actuated arrangement. In an example, the actuators may pivot or otherwise move a connector of the high pressure feed 114 into alignment with the well and a connection may be established between the high pressure feed 114 and a conduit. Other implementations are also possible.

Available capacity and status of numerous parts of the system 200 can be known by each of the distributed processing circuits in light of current performance and continuous or periodic sensor signals. In some embodiments, the distributed processing circuits may be configured to selectively modify available system resources for the mode, state, and selected independent variables being controlled. In a particular example, the mode, the state, and the measured variable information can be used by the distributed processing circuits to determine a hierarchy of control decisions impacting generation and distribution of power (via the turbine power unit 102), extending the life of the system 300 by managing removal (transferring heat to the cooling systems), and by managing modes of generation of heat (e.g., excitation waveforms driving the actuators and motors). The system can provide very high-power output for durations limited by temperature rise and cooling capacity, which are managed locally by the distributed controls system so as not exceed local limits, including but not limited to inertial cooling capacity. Further, the distributed processing circuits may be configured to identify, report, and mitigate incipient failures. Other observable aspects, such as vibrations and pressure fluctuations, can be detected, analyzed, and utilized by distributed processing circuit. The plurality of distributed processing circuits may cooperate to provide an overall machine health management system.

The distributed processing circuits of the system 200 can mitigate incipient failures by shifting loads, predicting the available power, and optimizing the operating availability of the system in adverse circumstances and in the event of multiple failures. The distributed processing circuits may be configured to cooperate to provide a machine health management system and method that can allow preventive maintenance to be scheduled, while significantly enhancing deployed reliability. Field repairs of fluid-end components can be performed during the time between pumping stages, or deferred for maintenance at the shop, because the overall capabilities system can be otherwise maintained and the impact of failures and remaining life can be predicted and aggregated into larger multi-system fleets and the accompanying management tools.

The processing circuits implementing the health management systems and methods may also encompass fluid-end health management, allowing single cylinders of any one of the fluid ends 282 to be isolated, disconnected, or entire cylinder banks to be isolated while compensating to maintain the demanded pump output, system output, surface or downhole pressure, or flow demanded, such as by changing the RPM of one or more motors 278 and associated pumping elements 280. In the event that torque or power limits demanded exceed the capacity or other parameters that are known to be available, certain cylinders may be bypassed, disconnected, or isolated to apply the available torque or power to a reduced number of cylinders, or to run at a higher RPM, without changing plunger sizes.

Multiple oil condition or dielectric fluid variables can be monitored, while any diminution of oil fluid quality can reported and evaluated by the various processing circuits or by a control system implemented as part of the operator's cabin and user interfaces 104. The processing circuits may cooperate to reduce the operating authority the system 200 can demand of the affected components until the condition has been approved. Operator overrides may be available, but may be staged with warnings regarding impact on machine life and cost of repairs that will be incurred.

Redundant information (shared between the plurality of processors and across various parts of the system 200) can allow comparisons of data points for improved resolution, the ability to identify and disregard erroneous information, increased efficiency and maximization of the availability and life of the system, while mapping any maintenance to be schedule and conducted to a suitable time and place. The use of distributed control by analog and digital circuitry and associated methods, such as cost functions and variational techniques, may increase efficiency and substantially increase the mean time between failures.

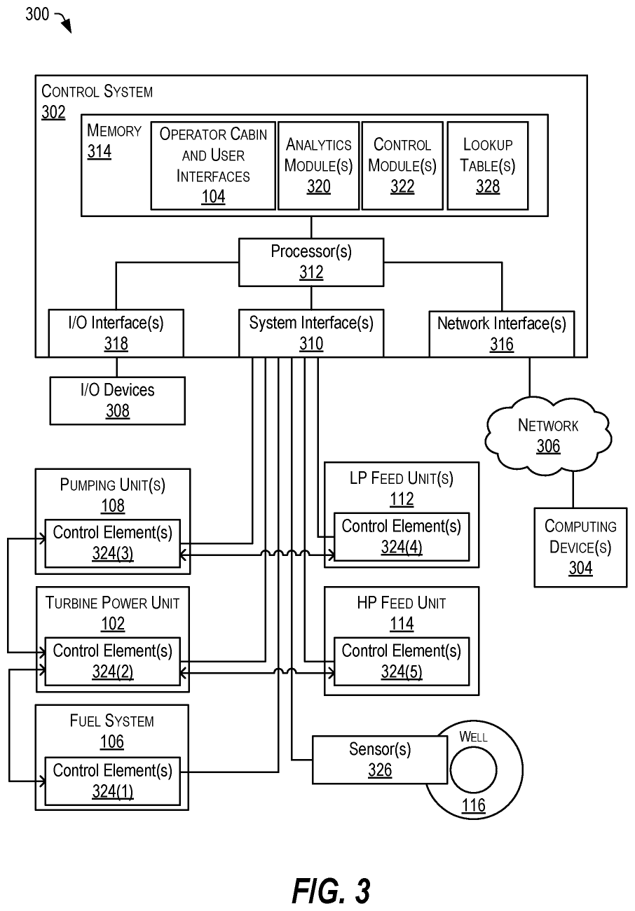

FIG. 3 depicts a block diagram of a system 300 including a control system 302 and a plurality of distributed control elements 324, in accordance with certain embodiments of the present disclosure. The system 300 may be an implementation of the system 100 of FIG. 1. It should be understood that the system 300 may be comprised of a plurality of control elements 324, which may be distributed between subsystems and which may be configured to communicate with one another. Each of the control elements 324 may be configured to exercise autonomous control over associated components within the same subsystem. Further, each of the control elements 324 may be configured to communicate with one another to provide semi-autonomous control within a subsystem, between subsystems, or both. Additionally, each of the control elements 324 may communicate with one or more higher level control systems, such as the control system 302. Each control element 324 may include one or more sensors, one or more comparators, one or more pre-determined thresholds, and control logic (in some instances a microcontroller) allowing the distributed controller 324 to detect conditions associated with one or more components and to make adjustments to maintain a desired level of performance.

In the illustrated example, a control system 302 may communicate with one or more computing devices 304 through a network 306. It should be understood that the network 306 may include the Internet, one or more other networks (such as local area networks, private networks, communications networks (such a cellular networks), and so on. The computing devices 304 may include laptop computers, tablet computers, smartphones, other computing devices, and so on.

The control system 102 may be coupled to one or more input/output (I/O) devices 308 to provide information and to receive input data. The I/O devices 308 may include one or more output devices, such as a display, a touchscreen, a printer, a speaker, other I/O devices, or any combination thereof. The I/O devices 308 may further include one or more input devices, such as a keyboard, a pointer, a keypad, a touchscreen, a scanner, a camera, a microphone, other input devices, or any combination thereof.

The control system 302 may also be coupled to various subsystems, including one or more turbine power units 102, a fuel system 106, one or more pumping units 108, a low pressure feed unit 112, and a high pressure feed unit 114. In some implementations, the control system 302 may communicate with control elements 324 in each of the subsystems. Further, the control system 302 may be coupled to one or more sensors 326 associated with the well 116.

The control system 302 may include one or more system interfaces 310 configured to couple to the various subsystems and the sensors 326. The control system 302 may further include one or more processors 312 coupled to the system interfaces 310. Further, the processor 312 may be coupled to a memory 314, which may store data and processor-executable instructions. The processor 312 may also be coupled to the network 306 through one or more network interfaces 316 and may be coupled to one or more I/O devices 308 through one or more I/O interfaces 318.

The memory 314 may include operator cabin and user interfaces 104, which may cause the processor 312 to generate one or more user interfaces including data and selectable options accessible by the user to interact with and optionally control one or more subsystems or the system 300 as a whole. The memory 314 may further include one or more analytics module 320, which may cause the processor 312 to receive data from one or more of the control elements 324 and optionally from the sensors 326. The analytics module 320 may cause the processor 312 to analyze the received data to predict changes to the system 300 or the load (i.e., the well 116). The memory 314 may further include one or more control modules 322, which may utilize the received data and the predictive analysis to selectively send control signals to the control elements 324 and the various subsystems to adjust operation of the system 300 based on the received data.

The system 300 encompasses both the generation of power and the use of the power, and the control system 302 and the distributed control elements 324 may take advantage of a number of factors to provide desired performance. Those factors can include a priori knowledge of the command profile (the placement of the various control elements 324), the response (timing and capability) of each of the subsystems (turbine power unit 102, fuel system 106, pumping units 108, low pressure feed units 112, and high pressure feed units 114), critical limits of each of the subsystems, and the “reserve capacity” of each of the subsystems. For example, if a particular motor of one of the pumping units 108 has a safe operating range between 0 and 4500 RPM, the current operation of the motor may be below the upper RPM of the safe operating range (e.g., at 2,500 RPM), leaving a reserve capacity (e.g., about 2,000 RPM). Over the entire system 300, each component may have a reserve capacity representing headroom between its current operation and it capacity. The system 300 may take advantage of such information to maintain load balances and to make adjustments to preserve operation and optionally to adapt to changing conditions.

The manner of control and the manner of the power generation (across the entire system 300 as well as in the subsystems and in the modules therein) enables a high efficiency over a wide range of system power output, very high transient peak power operation when needed; while limiting the duration and magnitude of peak power generation by distributed control capable of prevention of exceeding critical limits locally. Each of the control elements 324 may provide local control of one or more components, providing distributed control and associated machine health management locally to prevent crossing of critical limits, which may vary with time, temperature, emergence of manufacturing defects, and so on. This local control by the control elements 324 may enable prevention of individual component hard failures, lengthening of the remaining life of weakened components by reducing demand on them (e.g. keeping temperature of weak component in line, and avoiding thermal runaway which might otherwise result in rapid failure), sharing of contributions (loads) to meeting demands of the system (such as commanded performance demands) by distributed control of redundant components according to their ability, and so on. Further, the control elements 324 may be configured to report degradation (device parameters, anomalies, and so on) for service-life prediction and planning the extent of the next preventive maintenance intervention (how soon, how much time is required, what parts may require changing and so on).

The control system 302 may continuously calculate the “reserve capacity” of the system 300 in terms of energy or power by measuring certain parameters; by taking advantage of its knowledge of the system 300 including its subsystems and components; by taking into consideration its knowledge of the system responses; by considering other parameters and other information; or any combination thereof. For example, a component may have a certain heat capacity and volume or mass known to the control system 302, so measurement of its temperature allows for calculation of the heat energy contained in that component. The control system may utilize a multi-dimensional lookup table that characterizes the heat transfer rates possible due to the component's geometry and based on the interfaces it has on its surfaces. The component may have a temperature limit that protects it from inelastic deformation, from a temperature that may cause an irreversible change in its structural or other properties, or from interference with or excess stress on the component or other components due to relative rates of thermal expansion, which considerations are known to that component's associated control element 324. Further, the system 300 may include a cooling fluid (such as a dielectric oil), which may have a density and heat capacity that changes significantly with its temperature. These properties may be known to various distributed control elements 324 and to the control system 302. In some implementations, the properties may be known by the distributed control elements 324 based on one or more lookup tables, based on one or more pre-determined threshold settings, based on control instructions executed by the microcontroller, or any combination thereof. For example, a distributed control element 324 may be associated with a component and it may know the heat capacity per unit volume at its measured temperature and the heat transfer rate associated with distributed control element. Thus, the distributed control element 324 can determine the energy contained in the component and can determine the rate of energy transfer. With this information, the distributed control element 324 can manage one or more components to reduce heat generation, to enhance heat transfer, and so on.

It should be appreciated that the control elements 324 may communicate with one another and with the control system 302. Each control element 324 may determine a reserve capacity of its associated component or components, and may communicate reserve capacity data as applicable, in accordance with how much more energy can be contained or transferred before a critical limit is reached.

In some implementations, the distributed control element 324 may increase the rate of energy removal, or reduce the rate of energy addition. In some implementations, the distributed control element 324 may predict a temperature rise based on predicted demand of the load or of one or more components of the system 300. Whether in the solid component or transferred to the liquid, the rates of temperature accumulation and dissipation can be used to predict the temperature changes, allowing the distributed control elements 324 to manage the components. Further, the control system 302 may utilize such information to determine reserve capacity and optionally to manage various components. In one possible example, the control elements 324 may operate to prevent one or more components from exceeding a critical limit, anticipating which effect may otherwise lag and thus cause the critical limit to be exceeded, reducing component life or causing irreparable failure.

It should be appreciated that these “reserve capacities” may change over time. Changes may be measured or inferred through calculation and state changes known by the distributed control element 324, thus allowing the distributed control element 324 to be able to manage components to provide peak transient power or to determine parameters to provide peak efficiency. In some implementations, energy capacity and the rate of transfer of energy of the components and of the system 300 may be used to manage the health of the various components and the overall machine health.

In some implementations, critical limits may include hard limits, such as a transition temperature that marks a change in material properties, or a voltage above which semiconductor properties are violated irreparably, or a current above which heat generated by resistance irreparably changes insulation properties, or a combination which causes phenomena degrading such properties. For example, partial discharge events may compromise insulation rapidly by repetition when temperature weakens insulation and voltage causes electrical stress that exploits latent defects in the material. Further, such heating, voltage, or current levels may exceed a yield strength threshold, causing significant fatigue shortening life or results in immediate failure. In another example, dielectric oil properties may changed by impurities introduced when the fluid or other materials exceed certain temperatures. In another example, magnetic properties may be irreversibly altered by a level of magnetic stress, susceptibility to which varies with temperature.

In one possible implementation, a system 300 may include one or more interfaces (system interfaces 310) coupled to a plurality of subsystems (turbine power unit 102, fuel system 106, pumping units 108, low pressure feed units 112, and high pressure feed units 114). Each subsystem may include a plurality of components (such as pumps, turbines, circuits, motors, and other components) and including one or more control elements 324. The system 300 may include a processor 312 and a memory 314 storing data and processor-executable instructions to cause the processor 312 to perform a plurality of operations. In one example, the processor 312 may receive data from each of the one or more control elements 324. The processor 312 may utilize the analytics module 320 to determine reserve capacities of each of the plurality of components and of each of the plurality of subsystems and to determine an overall reserve capacity based on the reserve capacities. The processor 312 may use one or more control modules 322 to selectively control a first component of the plurality of components by sending a control signal to a first control element (such as one of the one or more control elements 324(2)) that is associated with the first component of a particular subsystem, such as the turbine power unit 102.

In an example, the plurality of subsystems includes a first subsystem, such as the turbine power unit 102, which includes a first set of control elements 324(2) including a first control element and a second control element. For example, the turbine power unit 102 may include a turbine control unit 206, a fire suppression system 204, a fuel system 210, a lubrication system 212, a field winding control unit 218, a cooling system 220 and 228, a solid-state disconnection circuit 230, rectifiers, alternators, and so on. One or more of these elements may be associated with one or more control elements 324. In some implementations, each control element may include or may be associated with one or more sensors to measure one or more parameters of at least one component of the plurality of components. Further, the control elements 324 may be configured to communicate with one another. For example, the first control element may be communicatively coupled to the second control element to communicate data associated with the one or more parameters. Further, the control elements 324(2) may communicate data associated with the one or more parameters to the control elements 324(1), 324(3), and so on, and may communicate data associated with the one or more parameters to the processor 312.

In an example, the plurality of subsystem includes a turbine power unit configured to generate a medium voltage direct current power supply. Further, the turbine power unit may include a set of the one or more control elements 324(2) to control operation of one or more components of the turbine power unit 102, determine a reserve capacity of the turbine power unit 102, and communicate data related to the reserve capacity to the processor 312.

In another example, the plurality of subsystems includes one or more pumping units. Each pumping unit may include an input to receive a fluid at a first pressure, an output to provide the fluid at a second pressure that is higher than the first pressure, a plurality of electric motors to rotate a shaft, and one or more pumping units coupled to the shaft, the one or more pumping units to draw the fluid from the input and to drive the fluid through a plurality of fluid ends to the output. The plurality of subsystems may include a set of the one or more control elements 324(3) to determine first reserve capacities of each of the plurality of electric motors and second reserve capacities of each of the one or more pumping units 108. The set may communicate data related to the first reserve capacities and the second reserve capacities to the processor 312.

In a particular example, the processor 312 may determine a measured pressure at the well 116 based on signals from the one or more sensors 326. The processor 312 may determine a measured pressure at the well 116, compare the measured pressure to a fracture pressure to predict a change in operating conditions. In an example, the fracture pressure may include a predicted threshold pressure at which the rock of a well is expected to fracture. The processor 312 may determine when a difference between the measured pressure and the fracture pressure is less than a threshold amount. For example, when the measured pressure is within five percent of the fracture pressure, the processor 312 may predict that the pressure at the well is about to cause the well to fracture and may selectively control one or more of the plurality of subsystems in response to the predicted change. In a particular example, the processor 312 may send control signals to a cooling subsystem of the pumping units 108 and the turbine power unit 102 to draw heat away from those subsystems in advance of ramping up the power production and increasing pressure. Subsequently (and in some instances sequentially), the processor 312 may send first control signals to the turbine power unit 102 to increase power output and may send second control signals to the pumping unit 108 to increase motor speeds, pumping rate, and so on.

In one possible example, a system 300 may comprise a plurality of subsystems, where each subsystem includes a plurality of components and a plurality of control elements 324 to determine parameters of the plurality of components and to independently control one or more of the plurality of components in response to determining the parameters. The independent control may be autonomous (based on pre-determined thresholds corresponding to known limits of the components and current operating parameters), semi-autonomous based on communications from other control elements 324, and so on. The system 300 may further include a control system 302 including one or more interfaces 310 coupled to the plurality of control elements 324. The control system 302 may further include a processor 312, a memory 314 storing data and processor-executable instructions to cause the processor 312 to receive data from the plurality of control elements 324; determine an overall reserve capacity based on the reserve capacities; and selectively control a first component of the plurality of components by sending a control signal to a first control element (e.g., a control element of one or more control elements 324(2) of the turbine power unit 102).

For example, the turbine power unit 102 may generate a supply of medium voltage direct current power. A set of the plurality of control elements 324(2) to control operation of one or more of the plurality of components of the turbine power unit 102 may determine a reserve capacity of the turbine power unit, and may communicate data related to the reserve capacity to the processor 312. Other implementations are also possible.

In one possible example, the processor 312 may determine first information including energy content, total energy capacity, energy transfer rate, other response rate such as temperature, and critical limits of each of the plurality of components and of the plurality of subsystems. The processor 312 may determine second information related to interactions of the plurality of components and the plurality of subsystems with a surrounding environment. The processor may further determine third information including component responses to various fault management conditions, operational modes, and operational states. The processor 312 may determine the reserve capacity of each of the plurality of subsystems and of an overall system based on the first information, the second information, the third information, and data received from the control elements 324. In some implementations, the processor 312 may update a multi-variable lookup table (LUT) 328 based on the determined reserve capacity.

In some implementations, the processor 312 may determine limits of each of the plurality of components. The determined limits may include temperature, stress, voltage, and cumulative effects on such limits based on component fatigue, partial discharge, contamination, corrosion, and other measurable forces including voltage, temperature, current, pressure, tension, stress, and strain. The processor 312 may communicate the determined limits to the one or more control elements 324. Further, in a particular example, the processor 312 may send one or more control signals to the one or more control elements 324 to change states or modes of the plurality of components to alter the reserve capacity of one of the plurality of components and of the subsystems.

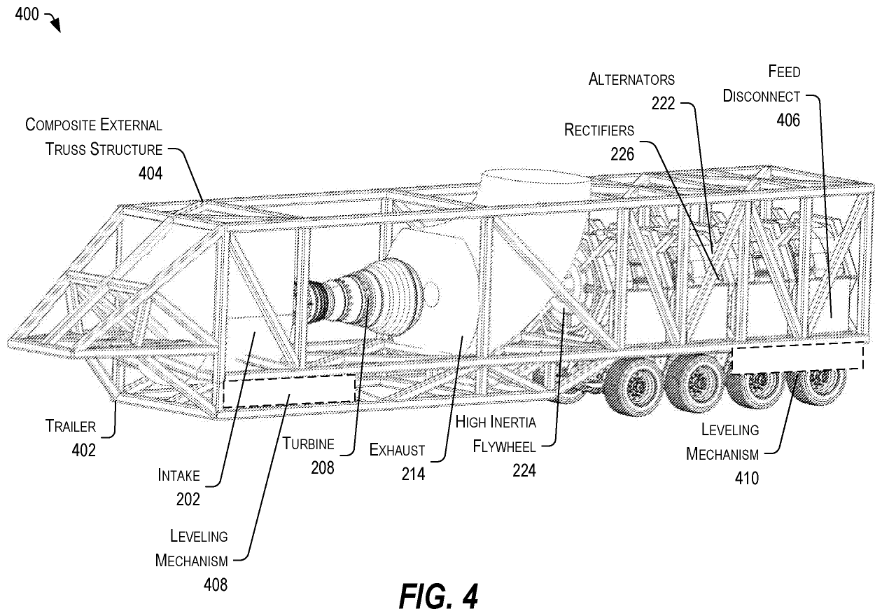

FIG. 4 depicts a perspective view of the power generation portion 400 of the integrated electric hydraulic fracturing system 100 of FIGS. 1-2B, in accordance with certain embodiments of the present disclosure. The power generation portion 400 may be housed and transported on a trailer 402, which may include an external structure 404 formed from a composite material, such as carbon fiber.

The power generation portion 400 may include an intake 202, a turbine 208, and an exhaust 214. The turbine 208 may be coupled to a shaft which may be coupled to a high inertia flywheel 224. The shaft may be coupled to a plurality of alternators 222 and rectifiers 226, which may generate a rectified power supply coupled to one or more other systems (such as the pumping units 108 and the low pressure feed units 112 through a feed disconnect 230, which may include high speed, solid-state disconnect circuitry.

In the illustrated example, the turbine power unit 102 is installed on a movable trailer 402, which may incorporate a leveling system, including leveling mechanisms 408 and 410, which may be extended to provide leveling and stability. The trailer 402 may include an external structure 404 that can include a composite full-height truss configuration with integrated alignment tensioners. In some embodiments, the trailer 402 may include processing circuitry and sensors configured to provide automatic optical alignment and vibration sensing and analysis to simplify and speed setup, monitor vibrations, and correct changes under machine control or optionally under operator control. Other embodiments are also possible.

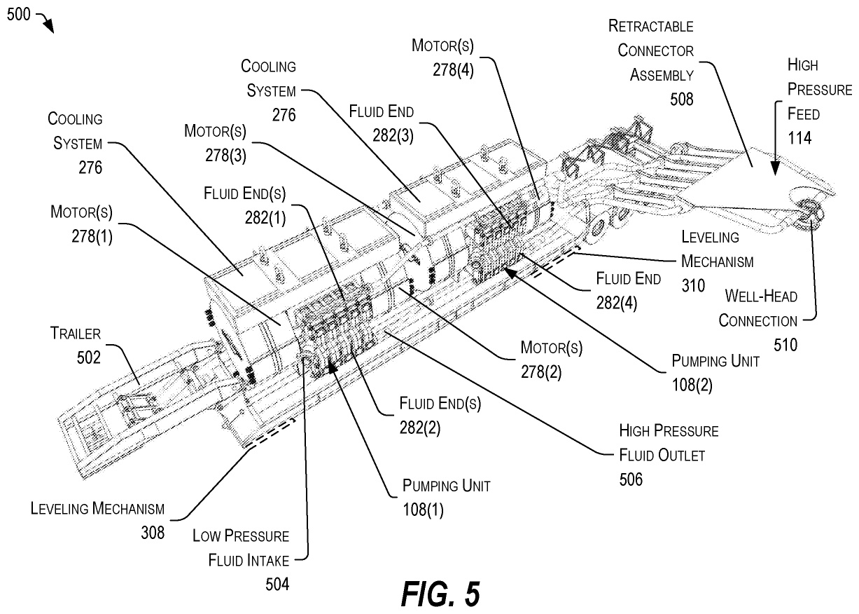

FIG. 5 depicts a perspective view of the pumping portion 500 of the integrated electric hydraulic fracturing system 100 of FIGS. 1-3, in accordance with certain embodiments of the present disclosure. In the illustrated example, the pumping portion 500 may include a trailer 502 configured to secure and transport a plurality of pumping units 108(1) and 108(2). Each pumping unit 108 may include a plurality of motors 278 and a plurality of pump elements 280. The pumping unit 108(1) may be coupled between a first pair of motors 278(1) and a second pair of motors 278(2). The pumping unit 280(2) may be coupled between a first pair of motors 278(3) and a second pair of motors 278(4). The motors 278 may be coupled to and configured to turn a shaft. The shaft may rotate, causing the banks of pistons and other components (e.g., eccentrics, bushings, and so on) of the pumping units 108 to move, causing the pistons to move back and forth.

The pumping portion 500 may further include a plurality of low-pressure fluid intakes, such as the low-pressure fluid intake 504, which may be coupled to one or more low-pressure feed units 112 (in FIGS. 1 and 2B). Further, the pumping portion 500 may include a plurality of high-pressure fluid outlets, such as the high-pressure fluid outlet 506, which may be coupled to the high pressure feed 114. The high pressure feed 114 may be coupled to the trailer 502 by a retractable connector assembly 508 and a well-head connection 510. The fluid ends 282 may drive the fluid into to the high pressure fluid outlet 506. Further, the pumping portion 500 may include a cooling system 276, which may provide oil cooling of the pumping units 108 and the motors 278.

In the illustrated example, the motors 278 may include direct-drive, high-torque, low RPM electric motors with integrated drive electronics, which may be managed so as to ensure high reliability, low maintenance and long life, at very high-power levels in a challenging, mobile environment. The pumping portion 500 combines composite materials, oil-cooled power electronics and magnetics to achieve required power levels within transportation limits and at significantly reduced cost compared to conventional systems. The cooling system 276 makes use of oil or dielectric fluid cooling for electronics and magnetics in generation and distribution and in the motive power devices, which is enabling and novel. Further, each pumping unit 108 and each motor 278 may include multiple processing circuits at a device level and within subsystems, such as subsets of the stator coils. The processing circuits may provide monitoring, control, and management of numerous, different variables.

In some embodiments, the processing circuits may be distributed across multiple systems and at multiple layers within the system. The use of distributed controllers in a layered system and method enables the turbine 208, generator or alternator 222, pump elements 280, and fluid feed systems to achieve efficiencies, instantaneous power levels, reliability, and life span not achieved in conventional systems.

The system 500 allows use of multiple pumping units 108A, combined on a trailer 502 with a mechanized high pressure, high flow conveyance system (such as, high pressure feed 114) to connect to the wellhead via the well-head connection 510. The system 500 can be implemented in conventional, steel high pressure fluid components or can be embodied in a lighter system with hybrid or composite components including connections and swivels, to minimize flow rates and accompanying pressure drops and erosion problems. The retractable connector assembly 508 may include a plurality of actuators configured to allow a range of motion that is intuitive to the operator, facilitating the connection by combining the behavior of multiple actuators, which in turn may be configured in a novel, electrically actuated arrangement.

Available capacity and status of numerous parts of the system 500 and of the overall system 100 can be known from the local processing circuits, and the processing circuits can modify available system resources for the mode, state, and selected independent variables being controlled. This information can be used in multiple parallel aggregated hierarchies of control decisions impacting generation and distribution of power. Further, the processing circuits can be used to extend the life cycle of the system and its components by managing generation (work) and removal (cooling) of heat. Further, the processing circuits may be configured to identify, report, and mitigate incipient failures. Other observable aspects, such as vibrations and pressure fluctuations, can analyzed and acted upon and utilized by the plurality of processing circuits to provide the machine health management system.

In some embodiments, the various processing circuits of the system 500 may be configured to cooperate to mitigate incipient failures by shifting loads between banks of pistons of a pumping unit 108, between pumping units 108, or any combination thereof. Further, in some embodiments, groups of stator coils of the motors 278 may each include one or more processing circuits, making it possible to selectively activate, deactivate, and adjust each subset or group of stator coils independently, while communicating with other processing circuits of other subsets or groups to make corresponding adjustments, such as to take on load or to reduce load. Other examples are also possible.

The distributed processing circuits make it possible to mitigate failures if they occur, and to predict the available power and optimize the operating availability of the system in adverse circumstances and in the event of multiple failures. Each of these distributed processing circuits may be configured and empowered to dynamically and automatically adjust one or more components in response to various parameters and to communicate with other processing circuits to enable the system to dynamically and automatically respond to changing conditions. These distributed processing circuits enable a machine health management system and method that can allow preventive maintenance to be schedule, while significantly enhancing deployed reliability. Field repairs of components within the fluid-ends 282 can be performed during the time between pumping stages, or deferred for maintenance at the shop because the overall capabilities system 500 can be otherwise maintained and the impact of failures and remaining life can be managed and predicted.

The system 500 may further include processing circuits to provide health management of the fluid-ends 282, allowing single cylinders to be isolated, disconnected, or entire cylinder banks of the pumping units 108 to be isolated while compensating to maintain the demanded pump output, system output, and the surface or downhole pressure or flow demanded, such as by changing the RPM of the motors 278 and of one or more pump units 108. In the event that torque or power demanded exceed a capacity that is known to be available, certain cylinders may be bypassed, disconnected, or isolated to apply the available torque or power to a reduced number of cylinders, or the motors 278 may be controlled to operate at a higher RPM, without changing plunger sizes.

Multiple oil condition variables of the cooling system 276 can be monitored and improved, while any attribute or parameter of oil quality can be reported and evaluated by various processing circuits of the system 500 or the larger system 100. The processing circuits may dynamically reduce the operating authority the system can demand of the affected components until the condition has been approved. Operator overrides are available, but staged with warnings regarding impact on machine life and cost of repairs that will be incurred.

Redundant information across various processing circuits of the system 500 may allow comparison of sensor data and various parameters for improved resolution, the ability to identify and disregard erroneous information, increased efficiency and maximized availability and life-cycle of the system 500, while mapping any maintenance to be schedule and conducted at a suitable time and place. The use of distributed control by analog and digital processing circuits and methods enables various cost functions and variational techniques that can increase efficiency and substantially increase the mean time between failures.

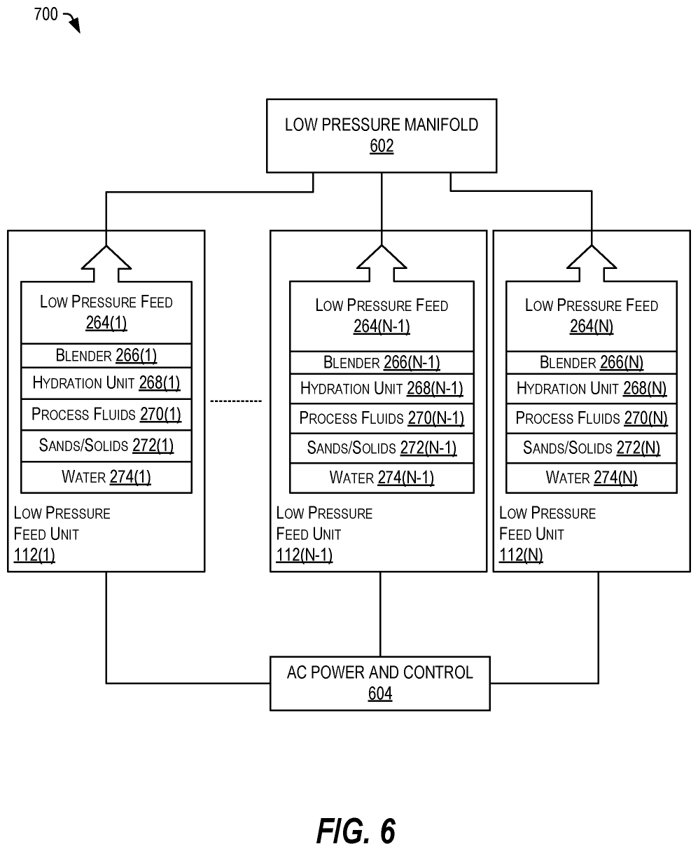

FIG. 6 depicts a block diagram of a low-pressure process fluid delivery system 600, in accordance with certain embodiments of the present disclosure. The system 600 may include a plurality of low-pressure feed units 112, each of which may be coupled to a low pressure manifold 602, which may be coupled to the low-pressure fluid intakes 504. Further, each of the low-pressure feed units 112 may be coupled to an AC power and control system 604 to receive power and commands. The AC power and control system 604 may be part of the turbine power unit 102.

Each low-pressure feed unit 112 may include a water tank 274, a sand/solids tank 272, a process fluids tank 270, a hydration unit 268, and a blender 266. The blender 266 may be configured to mix water, sand/solids, and process fluids to produce a fracturing fluid, which may be provided to a low pressure feed 264. The hydration unit 268 may be configured to manage the mixture components. Other embodiments are also possible.

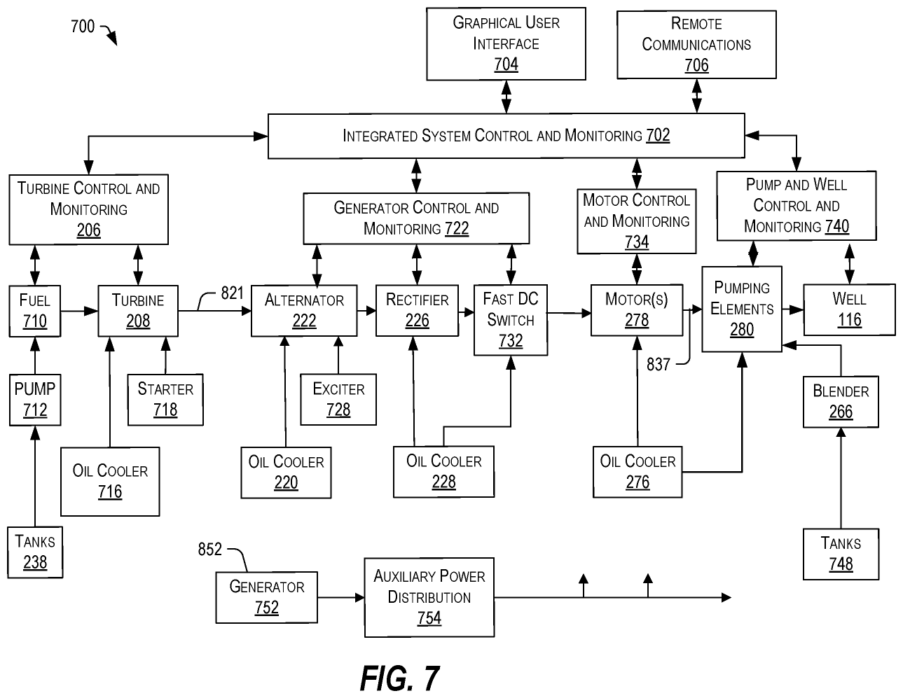

In general, the overall system may include a plurality of processing circuits, which may be configured to control operation of one or more components in view of a plurality of sensor signals and a plurality of system parameters. One possible embodiment of a simplified overall block diagram of the Integrated Electric Hydraulic Fracturing systems and methods is described below with respect to FIG. 7.

FIG. 7 depicts a block diagram of the integrated electric hydraulic fracturing system 700, which may be an embodiment of the integrated electric hydraulic fracturing system of FIG. 1 and which may be part of the various components described with respect to FIGS. 1-6, in accordance with certain embodiments of the present disclosure. The system 700 may include an integrated system control and monitoring system 702, which may be configured to control and monitor operation of the overall system.

In some embodiments, the integrated system control and monitoring system 702 may include a processing circuit, such as a Programmable Logic Controller (PLC), ECD, or other rugged industrial processor with fast remote input/output (I/O) capabilities. Any communication between the I/O of the integrated system control and monitoring system 702 and various processing circuits of the system 700 may be through optical fibers because of the extremely high electromagnetic noise environment and isolation requirements around the high power switching motor drives.

The integrated system control and monitoring system 702 may be configured to provide a graphical user interface 704, through which a user may interact with the integrated system control and monitoring system 702 to manage operation, to configure operating parameters, and so on. The system 702 may also be configured to receive remote communications 706 from remote devices, such as computing systems or other devices through a direct wired connection, an Ethernet connection, through another communications path, or any combination thereof.

The integrated system control and monitoring system 702 may be coupled to a turbine control and monitoring system 206, which may include a plurality of processing circuits. The turbine control and monitoring system 702 may be coupled to a fuel injection system 710 coupled to a turbine 208. The fuel injection system 710 may be coupled to one or more fuel tanks 238 through a pump 712. The turbine 720 may be coupled to an oil cooling system 716 and to a starter 718. The turbine 208 may be coupled to a shaft 721, which may be coupled to an alternator 222.

The integrated system control and monitoring system 702 may be coupled to a generator control and monitoring system 722, which may be coupled to the alternator 222. The alternator 222 may be coupled to an oil cooler 220 and to an exciter 728. The alternator 222 may be configured to generate an electrical current from rotation of the shaft 721. The alternator 724 may be coupled to a rectifier 730 and to a motor 736 through a fast DC switch 732. The generator control and monitoring system 722 may be coupled to the rectifier 226 and to the fast DC switch 732. An oil cooler 228 may be coupled to the rectifier 226 and to the fast DC switch 732.

The integrated system control and monitoring system 702 may also be coupled to a motor control and monitoring system 734, which may be coupled to a motor 278 configured to receive power from the fast DC switch 732. The motor 278 may be coupled to an oil cooler 738. The motor 278 may be coupled to a shaft 737, which may drive one or more pumping elements 280.

The integrated system control and monitoring system 702 may also be coupled to a pump and well control and monitoring system 740, which may be coupled to the pumping elements 280. The pumping elements 280 may be coupled to an oil cooler 744. Further, the pumping elements 280 may include an input coupled to an output of a blender 266, which may include an input coupled to one or more tanks 748. The pumping elements 280 may also include an output coupled to a well 750. The pump and well control and monitoring system 740 may also be coupled to the well 116 to sense one or more parameters.

In some embodiments, in addition to the turbine 208, the alternator 222, and the rectifier 226 for generating power, one or more alternative energy sources may be included, such as for failover. In the illustrated example, the system 700 may include a generator 752 (such as a diesel generator) and an associated auxiliary power generation system 754, which may be coupled to one or more of the components of the system 700 to deliver auxiliary power. Similarly, such sources may be used for starting the turbine or continuing cooling during shutdown. Other embodiments are also possible.

All the ancillary pump and fan motor drives can be powered by either conventional 60 Hz 480 VAC from a few 100-kW generator or by down converting MVDC to 600 VDC from the main turbine system. A separate generator, not shown, may be used for the control and monitoring system 702, which may be preferable for maintenance and initial set up to minimize fuel costs and personnel discomfort and hazards. The main control and monitoring system 702 may also command the gas turbine 208, the alternator 222, and the fast solid state MVDC disconnect control systems (which may be part of the fast DC switch 732).

Within the turbine power unit 102, the alternator field may be the only controllable variable other than the cooling pump and fans. During start up, the alternator field may be ramped up from zero to function as a soft-start charging of the main pump motor energy storage capacitors. Bulky motor drive input contactors and soft-start resistors or silicon controlled rectifiers may not be necessary. Except for low power or idle operation, the alternator field may be set to regulate the DC bus voltage to a specified supply voltage, such as about 8 or 12 kVDC or another voltage. The main rectifier may be uncontrolled and oil cooled. In an alternate embodiment, the alternator 222 and rectifier 226 have more than three phases and six pulses. Six, nine, and more phases, as well as 12, 18 and 24 pulse rectifiers, are possible variations. The fast solid-state disconnect (e.g., fast DC switch 732) may be closed during start up and may open when the particular circuit needs to be disabled. The solid state disconnect can be configured to monitor two line currents to detect internal faults, and also to monitor the softly grounded mid-point to detect internal shorts to ground. Microsecond disconnect speeds may greatly decrease equipment damage during a fault and also greatly decrease arc flash and operator hazards. The fast disconnect (fast DC switch 732), the rectifier 226, and the alternator 222 can all be collocated with a common oil cooler or can be located in separate cabinets and set any distance apart. The rectifier 730 and the solid state disconnect (fast DC switch 732) are preferably oil immersed for cooling and electrical insulation, and thus can be protected from the harsh frack field environmental conditions.

The main system control and monitoring system 702 may also control and monitor the fuel and turbine control systems. For a given requested turbine power, a look up table can be used in the turbine control system 708 to provide an initial set up for the fuel flow and air (bypass bleed valves) requirements. Further, the main system control and monitoring system 702 may also have direct access to the main fuel shut off valves and to controllers configured to trigger the fire suppressant system.

For a given frack schedule, the input power (fuel, alternator or motor, all being the same/proportional) may be commanded to a given constant level, producing a large initial fluid flow assuming the well pressure starts low. The fluid flow may be decreased as the well pressure increases for a constant turbine and motor power.

It should be appreciated that a pump may include four motors and five slotted crosshead assemblies to drive four banks of pistons. The motor control and monitoring system 734 may include four motor controllers, each of which may be configured to directly receive a number of sensor signals at ground potential, including a rotor position, a plus or minus DC voltage and current measurement, a coil temperature, an oil temperature, an insulated gate bipolar transistor (IGBT) temperature, and so on. Each of the motor controllers of the motor control and monitoring system 734 may be configured to calculate a current for each of six independent phases. In this example, the stator of each of the electric motors may include 48 stator coils, which may be grouped into subsets of six coils each. Each subset of six coils may include one or more processing circuits, which may be configured to independently control the current to the subset and to communicate with other processing circuits of the other subsets or wedges.

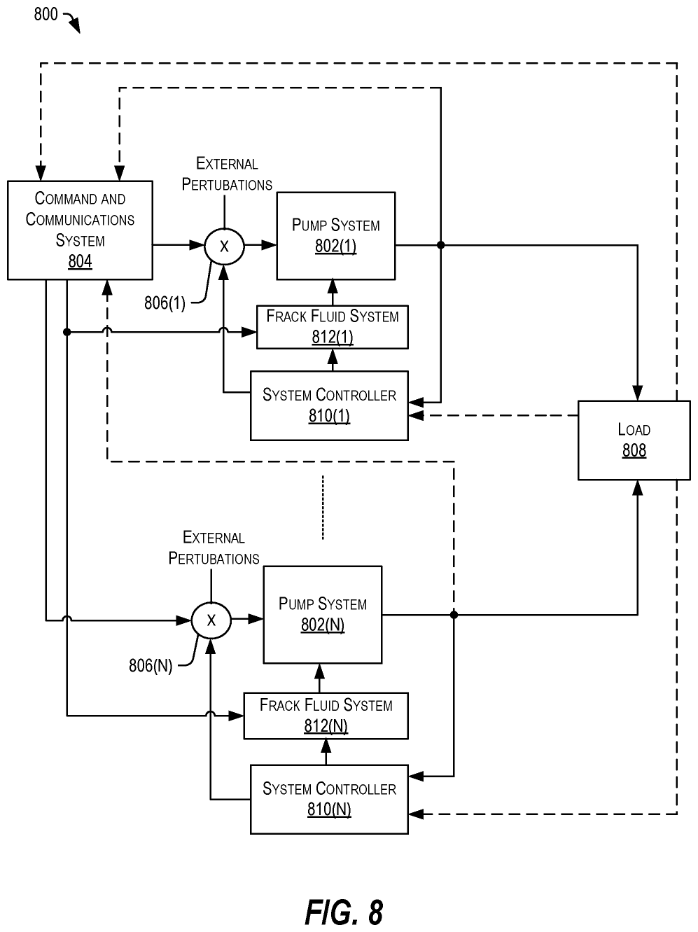

FIG. 8 depicts a block diagram of a plant system 800 representing the integrated electric hydraulic fracturing system of FIGS. 1-7, in accordance with certain embodiments of the present disclosure. The system 800 may include one or more pump systems 802, in accordance with certain embodiments of the present disclosure. The pump system 802(1) may include a plurality of motors coupled to a power end configured to convert rotary motion into linear motion transverse to a rotating axis. Further, the pump system may include a plurality of banks of positive displacement pistons (“fluid ends”) coupled to the power end and configured to move linearly in response to rotation of the rotating axis. The pump system 802 may include an input coupled to an output of a summing node 806(1) and may include an output coupled to a load 808.

The system 800 may include a command and communication system 804 including a first input coupled to the output of the pump system 802(1), a second input coupled to the load 808, and an output coupled to an input of the summing node 806. The summing node 806(1) may further include an input configured to receive external perturbations, such as noise, vibration, interference, and various other system influences. The command and communications system 804 may include one or more processing circuits and associated memory and may be configured to provide a graphical interface through which an operator may interact with the system 800. In some embodiments, the command and communications system 804 may be configured to provide control signals, automatically or in response to operator inputs, which control signals may be provided to the summing node 806(1) to influence operation of the pump system 802(1). In a particular embodiment, the command and communication system 804 may be configured to communicate wirelessly using radio frequency signals or via wired connections, such as one or more Ethernet connections, one or more fiber optic connections, one or more controller area network (CAN) connections, and so on. Further, the command and communication system 804 may be configured to manage security and encryption of data as well as communication signals. The command and communication system 804 may also include a program memory configured to enable control as well as to manage system interrupts.

The system 800 may further include a system controller 810(1), which may include a first input coupled to the output of the pump system 802(1), a second input coupled to the load 808, and an output coupled to an input of the summing node 806(1). The system controller 810(1) may be configured to receive sensor data from one or more sensors associated with the load 808 or coupled to the output of or integrated within the pump system 802(1) and may generate a feedback adjustment based on a selected mode of operation and based on data determined from the sensor signals. The sensor signals may include a rotor position signal, plus and minus DC voltage and current signals, coil temperature signals, oil temperature signals, switching temperature signals, and so on. Further, the system 800 may include a frack fluid system 812(1) responsive to signals from at least one of the command and communications system 804 and the system controller 810(1) to provide frack fluid to the pump system 802(1).

It should be appreciated that the system 800 may include multiple pump systems 802(1) to 802(N). Each of the pump systems 802 may include an input coupled to a summing node 806 and an input coupled to a frack fluid system 812 and an output coupled to the load 808. The output may be coupled to the same load as the other pump systems 802 or a different load, depending on the implementation. Further, each summing node 806 may be coupled to the system controller 810. While the discussion has largely focused on fracking fluid, it should be appreciated that the system 800 may be used in a multi-fluid or fluid-gas style system. Other implementations are also possible.

Since heat contributes to system component failure and degrades performance, the system controllers 810 may be configured to selectively adjust current flow, voltage levels, oil flow, fan cooling, and so on. The system controllers 810 may represent a plurality of distributed processing circuits, which may be integrated within the pump systems 802 (including power wedge processing circuits, motor processing circuits, valve control processing circuits, and system level processing circuits).

In some embodiments, the system controllers 810 may be integrated within the power electronics of the pump system 802. In a particular embodiment, the system controller 810 may be distributed across a plurality of electromagnetic wedges within the motors of the pump system 800. Further, the system controllers 810 may be distributed within the pumps and associated with each block of pistons or with each piston. Additionally, the system controllers 810 may include processing circuits configured to manage operation of the system 800; processing circuits configured to manage operation of multiple systems 800 in series, in parallel, or any combination thereof; and system-level processing circuits configured to manage operation of larger systems, generators, and so on. Other embodiments are also possible.

In a particular example, the system 800 may include distributed processors or distributed processing circuits configured to monitor, analyze, and act to maintain a consistent output in response to incipient or actual failures. This capability is referred to herein as “machine health management.” It should be understood, as discussed above, that processing circuitry may be included within various components of the system 800, including within wedges representing groupings of stator coils within each motor, at a motor system level, with each piston, with each valve, with a block of multiple pistons and valves, at the pump level, within other components (such as the cooling system), within a computing device associated with multiple pump systems 802, and so on. Each processing circuit may be configured to monitor, interpret, and act on signals associated with a particular component or grouping of components within the system and may communicate data to other processing circuits at the same level or at higher levels. One or more of the processors or processing circuits (such as a motor processing circuit, a system-level processing circuit, and so on) may be configured to apply analytics to measured parameters, historical data, and other data to determine trends and to predict operational variations. The analytics data may be presented to an operator through the graphical user interface. Trend analysis and reporting allows the user/operator to plan maintenance rather than incur total failure during a pumping operation. Further, the individual processing circuits may be configured to control operation and to initiate operational adjustments at selected levels (e.g., within a single wedge of a motor that has multiple wedges) and to communicate with other processing circuits so that the overall operation of the motor can be maintained, within critical limits. For example, the processing circuit may reduce current and/or voltage applied to the coils within the particular wedge, while nearby processing circuits may provide a corresponding increase in current and/or voltage in order to maintain overall operation of the motor. In some embodiments, the cooling system may also be notified by the processing circuit in order to adjust oil coolant circulation and to adjust the fan to increase airflow.

In another example, the processing circuits associated with a particular block of pistons may be configured to selectively open or close valves and optionally to activate a hydraulic or mechanical system to disengage a selected block of pistons in response to sensor signals. Other examples are also possible.

In general, by distributing processing circuitry within the various components and systems, perturbations to the system, heating events, and various anomalies may be readily detected and acted upon quickly and at a local level, without having to send a signal to a higher-level control system and wait for instructions. Instead, the local processing circuitry may take action to mitigate the event and may notify other processing circuits to make corresponding adjustments either to assist in the mitigation (e.g., increase cooling efforts, assume a portion of the load, and so on) so that performance of the system 800 can be maintained. By providing control at a level close to the event, the response time may be enhanced.

Further, the system 800 may be configured to operate despite multiple partial failures, while informing the user/operator of its status, remaining capacity, and predicted service life. A multiplicity of systems 802 may be employed (integrated) within a larger system. The command and communications system 804 may be configured to manage capabilities between multiple pump systems 802, making it possible to dynamically share the load as well as to respond rapidly to changes in the load demanded. Further, integration of the system controller 810 within the various pump systems 802 may be configured to respond quickly perturbations that affect the system response compared to the varying load demanded or desired. Further, the system controller 810 may enable the ability to isolate cylinders or cylinder banks to provide high pressure at a selected (sometimes maximum) RPM allowed based on the available power.

The processing circuits of the pump system 802 may have the ability to observe and to mitigate cyclical or isolated variations in torque (torque ripple) caused by the motors and the load of the power-end on the common shaft. In a particular example, the system controller 810 may be distributed across the motors of the pump system and may be configured to selectively control portions of the motors independent of other ports. In certain embodiments, a rotating shaft or axle of the power end may be stiff, by means of geometry and material modulus, to minimize undesirable energy storage and harmonic phenomena. Such undesirable energy storage and harmonic phenomena may be further mitigated by mechanical and electronic means of damping, which may be integrated within the motors 278 and optionally within the fluid ends 282.

It should be appreciated that the embodiment of the system 800 provides a simplified view of a highly complex and integrated system, which may be configured to deliver more than 21,000 HHP from a single pump system 802. Multiple pump systems 802 may be combined in series and/or in parallel to provide a desired hydraulic horsepower. In some embodiments, the system 800 may be constructed in a single integrated unit or housing measuring approximately 108×160×72 inches and weighing less than 80,000 lbs. Other embodiments are also possible.

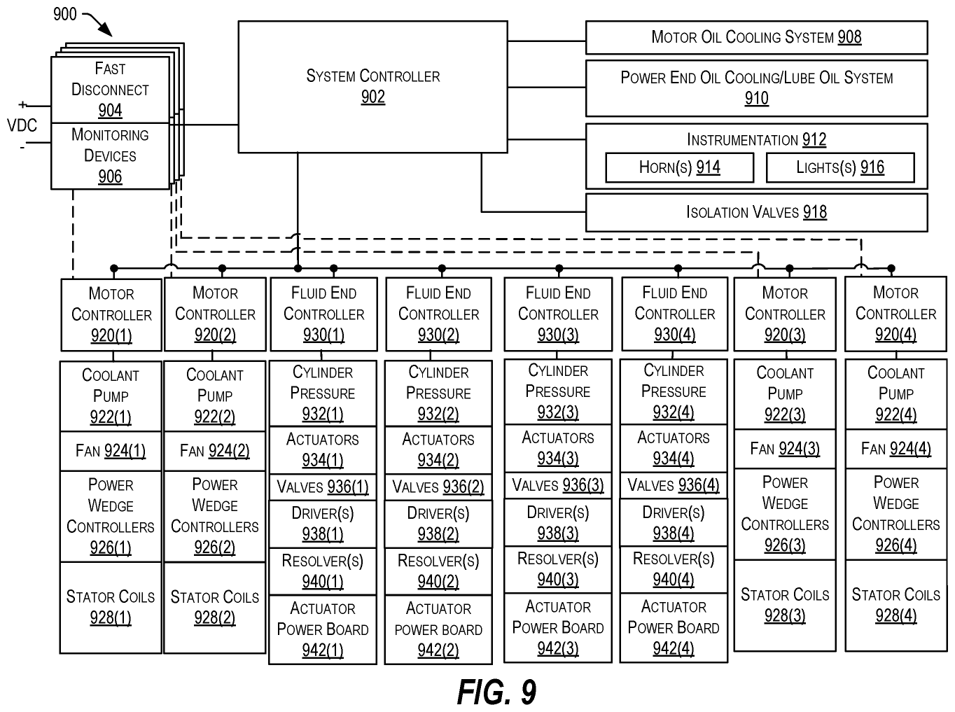

FIG. 9 depicts a block diagram of a system 900 including a pump system, in accordance with certain embodiments of the present disclosure. It should be appreciated that the system 900 may include all of the elements of the system 800 of FIG. 8 and may include additional details to facilitate understanding of the system. The system 900 may include a system controller 902 coupled to a fast disconnect 904 and monitoring devices 906. Further, the system controller 902 may be coupled to motor oil cooling system 908 and power end oil cooling/lube oil system 910. The system controller 902 may also be coupled to instrumentation, such as a plurality of sensors, as well as indicators, such as horns 914, lights 916, and so on. The system controller 902 may be coupled to one or more isolation valves 918, which may be used to isolate individual fluid ends or a bank of fluid ends. Other instrumentation may also be included.

The system 900 may include a system controller 900 coupled to a plurality of motor controllers 920 configured to control operation of the motors 278. Each motor controller 920 may be coupled to a coolant pump 922 and a fan 924 to dissipate heat produced by the motors 278 during operation. The motor controllers 920 may also be coupled to one or more power wedge controllers 926 within the motors 278. Each power wedge may include a microprocessor, switches, and driver circuitry configured to generate a selected waveform and to control one or more stator coils 928 (e.g., stator coils 928(1) and 928(2)), independently of other stator coils (e.g., 928(3) and 928(4), of a plurality of stator coils 928 within the motor 278. Each motor 278 may include a plurality of power wedges 926.

The system 900 may further include fluid end controllers 930. Each fluid end controller 930 may include one or more cylinder pressure sensors 932, one or more actuators 934, multiple valves 936 (an inlet valve, an outlet valve, and one or more relief valves), one or more drivers 938, one or more resolvers 940, and one or more actuator power boards 942.

Each motor 278 may include a rotor including a plurality of permanent magnets coupled to the shaft to drive rotation of the shaft. Each motor 278 may further include a plurality of stator coils 928 configured to drive the rotor rotationally. The power stator coils 928 may be grouped into wedges, which may be independently controlled using the power wedge controllers 926.

The pumps 922 may be configured to circulate oil and/or other coolant through the motors 278 to maintain a desired operating temperature. The fans 924 may be configured to circulate air within and across components of the motor 278 to provide active cooling.

Each of the motor controllers 920 may receive a number of sensor signals at ground potential including a rotor position signal, plus and minus voltage and current signals, and temperature signals (including coil temperature, oil temperature, insulated gate bipolar transistor (IGBT) temperature signals, and so on). Each motor controller 820 may calculate currents for each of the six independent phases of the power wedges.

In some embodiments, the three-to-six independent phases may have the same current-commanded signal shape and phase reference digitally encoded and transmitted to each of six power electronics wedges. A first and lowest (analog or digital) control loop may produce a pulse-width modulated (PWM) signal to its insulated gate bipolar transistor (IGBT) H-bridge circuit, which is compared to a fast coil current sensor signal. The current sensor can be a Hall affect sensor or another current sensor type. The motor controller 920 may monitor each of a plurality of drivers monitoring each of the voltages on each side of the wedge DC buses. The motor controller 920 may calculate the voltage across each wedge and as part of a second control loop may slightly increase or decrease power of each of the wedges to keep the DC bus voltages approximately the same. A third control loop may compare a requested power with an actual consumed power (product of the main DC bus current and voltage) and further correct the commanded currents.

In some embodiments, each wedge may include six independent H-bridge circuits and twelve dual insulated-gate bipolar transistor (IGBT) modules. This implementation may include six PWM analog or digital controllers, twenty-four isolated gate drivers, and six current sensors.

Each fluid end controller 930 may include a plurality of components. In an example, each fluid end controller 930 may include one or more cylinder pressure sensors 932, a plurality of actuators 934, and a plurality of valves 936. Further, each fluid end controller 930 may include a plurality of driver circuits (such as H-bridge drivers), one or more resolver circuits 940 configured to measure degrees of rotation of the shaft or axle, and an actuator power board 942 coupled to the H-bridge drivers, the actuators 934, and the valves 936. In some embodiments, the fluid-end controllers 930 may control operation of the positive displacement pistons of particular pump elements of the pump.

The direct drive motors 278 and the power-end require very little maintenance, especially compared to the number of large diesel engines, transmissions, reduction gears and conventional power-ends replaced hereby. The fluid-ends 282, incorporated into the pumping units 108, may be relatively high maintenance and prone to failure due to erosion of valves when pumping a fluid slurry containing a high percentage of proppant material, commonly known as sand. The incipient failures can be observed by analyzing pressure in each cylinder and vibration in each cylinder bank via sensors incorporated within the motors 278 and the fluid ends 282. In order to mitigate the impact of an individual cylinder failure, the pumping units 108 may include two means to isolate a failing cylinder, as well as a means to isolate a cylinder bank.

In one embodiment, a hydraulic element may be controlled to hydraulically isolate a selected cylinder. In another embodiment, a gear or clutch or other mechanical feature may be controlled to mechanically isolate the cylinder. In still another embodiment, a hydraulic or mechanical element may be incorporated that may be controlled to isolate a complete cylinder bank, which may also utilize one of the hydraulic and the mechanical element in order to unload the power-end. Other embodiments are also possible.

In some embodiments, the power-end (which may include the motors 278 and the pumping elements 280) may have the capacity to operate despite load imbalances that may result from isolating one or more cylinders or cylinder banks. Further, sufficient reserve capacity is available in the system 700 to maintain a selected pressure and flow rate by isolating one or more cylinders or cylinder banks and increasing the RPM of the power end or of the system 900.

The system 900 may include distributed processors to monitor, analyze, and act to maintain output in response to incipient or actual failures. This capability is referred to herein as “machine health management.” The system controller 902 may be configured to send data to and receive data from the command and communications system 804, which may apply analytics to the data, to historical data, and to other operating parameters and which may provide a graphical interface through which an operator may view the analytics data. Trend analysis and reporting via the graphical interface may allow the user/operator to plan maintenance rather than incur total failure during a pumping operation. Further, each of the components may include one or more processors, which may be configured to monitor various parameters, detect events, and selectively adjust one or more parameters of the associated component. By distributing the processing circuitry to the local components, the response time of the system is greatly enhanced. Further, the adjustments can be made locally and quickly, without waiting for a control signal from a master controller, extending the life cycle of the components and maintaining the overall health of the system.

The system 900 can continue to operate despite multiple partial failures, while informing the user/operator of its status, remaining capacity, and predicted service life. A multiplicity of systems 900 can be employed in a larger system, with capability between the pumping units 108 to share the load as well as to respond rapidly to changes in the load demanded or to perturbations that affect the response of the system 900 as compared to the varying load demanded or desired.

In some embodiments, the motor controllers 920 and the fluid end controller 930 may be configured to selectively activate or deactivate one or more components. The fluid-end controllers 930 may provide the ability to isolate one or more cylinders or cylinder banks to provide high pressure at the selected RPM (sometimes the maximum RPM allowed by the available power).

In some embodiments, the motor controller 930 can observe and mitigate cyclical or isolated variations in torque (torque ripple) caused by the motors and the load of the power-end on the common shaft. The rotatable shaft or axle may be stiff, by means of geometry and material modulus, to minimize undesirable energy storage and harmonic phenomena, which is further mitigated by mechanical and electronic damping. Each of the motors 278 may include a multiplicity of power wedges, including power electronics and electromagnets, which may be individually controlled and cooled. The resulting observability and controllability can be utilized in the machine health management functions that are distributed among the controllers in each power wedge and each motor.

Voltages, currents and temperatures can be measured at a multiplicity of locations, allowing individual limits to be honored, while sharing the load among the electromagnets, power wedges, and motors 278. Generally, the life of electronic components and insulation materials may be reduced by half by each 10 degrees Celsius of temperature rise above a rated temperature. By observing, controlling, and sharing the load, the life cycle of the pump units 108 may be extended and incipient failure may be predicted, but also mitigated, by reducing the load demanded of the comparatively hot components and by increasing the cooling. This load sharing may be achieved by inter-processor communication between processing circuits within each wedge of the motor's stator, for example, allowing one processing circuit to reduce current/voltage to the stator coils of its wedge and notifying other processing circuits within the motor to take up the slack. Further, the processing circuit may notify the cooling system to increase air flow and to increase coolant circulation. Other embodiments are also possible.

Power management and fast response to sudden failure may mitigate damage. Further, the operation of the system 900 may be preserved by partially or completely disabling power wedges or motors, via control signals from a power wedge processing circuit. In some embodiments, a low power, low stress mode of operation can be invoked prior to complete failure of a particular power wedge or motor by providing only the current required to counter the back electromagnetic force (EMF) and resulting torque seen by each electromagnet. This low-stress mode may be invoked by a motor-level processing circuit, by one or more wedge-level processing circuits, from signals from a system-level processing circuit, by control signals from another source, or any combination thereof.

In some embodiments, performance may be enhanced by deterministic computation and control of the electromagnetic field of each coil, which computation and control may be performed by one or more processing circuits within a wedge that includes the particular coil, by one or more processing circuits associated with the motor and outside of the particular wedge, or any combination thereof. As each power wedge sees the shaft angle and as the information is shared between a multiplicity of controllers 920, 930, and so on, the position in electrical degrees can be determined precisely.

Further, in some embodiments, the control of the optimum waveform for each individual electromagnet can be optimized by the motor controller 920 for a given motor, depending on a mode or state set by the system. The motor controller 920 may be configured to adjust the waveform for one or more of the electromagnets for selected power or efficiency at any given combination of available supply power, load commanded or observed, and environmental factors, such as ambient temperature and various internal temperatures. It should be appreciated that each motor controller 920 may represent a motor-level controller including one or more processing circuits configured to monitor, analyze, and act on sensor signals associated with the motor as a whole. Further, each motor controller 920 may represent wedge-level processing circuits configured to communicate with the motor-level controller and with one another. A wedge-level processing circuit may be configured to adjust the waveform for one or more of the electromagnets within a selected wedge for a selected power or efficiency at any given combination of available supply power, load commanded or observed, and environmental factors, such as ambient temperature and various internal temperatures.

In some embodiments, very fast transient responses at exceptionally high instantaneous or short duration power levels can be attained within the limits of the components and the available inertial and convective cooling. It may be possible to ramp from zero to full load in a single revolution. Further, in some embodiments, it may be possible to hold the motors stationary, or to advance in very small increments, to facilitate pressure testing of the fluid delivery system.

In a particular embodiment, oil cooling can be managed by coolant pumps 922 and fans 924. Expansion of oil due to temperature changes can be managed by means of bladders in expansion tanks. Oil quality in terms of particulates, dielectric strength, and moisture content can be observed and controlled by filtering in an oil quality subsystem that is part of the machine health management system. Filter differential pressures may be used to manage preventive maintenance. Separate reservoirs can be used to add, maintain, and clean or polish oil being added to or removed from the circulating system, preventing ambient temperature changes from introducing moisture and contaminates to the oil. A separate system (e.g., motor oil cooling system 806) can be used to manage the power-end oil from the electric motor cooling oil, although they may use the same type of oil.

The system controller 902 may communicate with the control system 700 and with various components using Ethernet connections, CAN connections, local wiring connections, or any combination thereof. Further, the system controller 902 may include program memory configured to enable control of the motor controllers 920 and fluid end controllers 930, including security, encryption, and interrupt management.

The system 900 may include power link control using the fast disconnects 904 and the monitoring devices 906. In an example, the power link control may be provided by the system controller 902, the monitoring devices 906, or both. In an example, the monitoring devices 906 may monitor the MVDC voltage and current and may detect transient spikes. The monitoring devices 906 or the system controller 902 may activate the fast disconnect 904 in response to detecting the transients. Further, the system 900 may include an electrical stop using an external disconnect, internal fast disconnects 904, local bypass or disconnect circuitry, and actuation (e.g., lights 916, horns 914, other components, or any combination thereof).

In some embodiments, the system 900 may include low pressure and high pressure manifolds including instrumentation 912. The low pressure fluid manifold may include pressure, temperature, flow, and vibration sensors or instrumentation 912, which may provide signals to the system controller 902. The system controller 902 may be configured to provide a fast Fourier transform (FFT) or other type of analysis to the plurality of sensor signals to determine feedback information, which may be used to adjust one or more of the motor controllers 920 and the fluid end controllers 930. Further, the high pressure manifold may include pressure, temperature, flow, and vibration sensors or instrumentation 912 or monitoring devices 906, which may be provide signals to the system controller 902. The system controller 902 may be configured to provide a FFT or other type of analysis to the plurality of sensor signals to determine feedback information, which may be used to adjust one or more of the motor controllers 920 and the fluid end controllers 930.

In operation, the system controller 902 may include information related to initial conditions and the state of the system. Further, the system controller 902 may be configured to maintain a calibration table for adjusting the various elements (motor controller 920 and associated components, fluid end controllers 930 and associated components, and optionally other elements). The system controller 902 may be configured to log data in memory using circular buffers and optionally a non-volatile memory configured to store historical data. Further, the system controller 902 may include analytics, such as a machine health interpreter/manager, configured to determine limits, provide exception reporting, perform trend analysis, provide redundancy, and provide compensation and load balancing. The system controller 902 may also include a command dictionary defining a plurality of commands, a data dictionary defining parameters of the system, a state dictionary defining various states of the system, communication protocols, and self-test/calibration tools.

In some embodiments, the system controller 902 may include an external interface and communications connection to a larger fracking system. Further, the system controller 902 may include a plurality of input/output interfaces configured to couple to a plurality of controllers, monitors, sensors, and actuators. The system controller 902 may include interfaces and connections to diagnostics as well as local power status and control instrumentation, micro-controllers, and actuators, such as the one or more processors within each wedge of the motor and the one or more processors associated with each piston or block of pistons of the pump. Other embodiments are also possible.

The motor controller 920 may include a motor oil condition monitor, configured to operate in conjunction with pumps 922 and fans 924 controlled by each motor controller 920. The motor oil condition monitor may be configured to determine oil levels, motor temperatures, dielectric parameters, moisture levels, particle levels, filter differential pressures, and so on. Further, the motor oil condition monitor may be configured to monitor valves to connect central/fill reservoir bladders for each motor system (if applicable), to control pump cleaning, and to control relief vents and bleed valves, which may include an indicator.

The fluid end controllers 930 may include a pump oil condition monitor, which may be configured to determine oil levels, pump temperatures, dielectric parameters, moisture levels, particle levels, filter differential pressures, and so on. Further, the pump oil condition monitor may be configured to monitor valves to connect central/fill reservoir bladders for each pump system (if applicable), to control pump cleaning, and to control relief vents and bleed valves, which may include an indicator.

In some embodiments, the fluid end controllers 930 may include input/output interfaces to cylinder pressure sensors, accelerometers, temperature sensors, pressure sensors, and analytics circuitry (configured to determine cylinder, fluid end analysis, and management). Further, the fluid end controllers 930 may include various actuators 934 (such as mechanical disconnect actuators, mechanical reconnect actuators, fluid bypass actuators, and high pressure fluid end isolator valve actuators), low pressure fluid end isolator valve actuators 934, driver circuits, resolvers 940, and actuator power boards 942.

The motor controllers 920 may include interfaces to cooling pumps 922, cooling fans 924, accelerometers, temperature sensors, pressure sensors, and management circuitry (such as cylinder, fluid end analysis, and management circuitry). The motor controllers 920 may include a plurality of power wedges, each of which may have one or more power wedge controllers 926. The motor controllers 920 may include power management including a DC link voltage connector and management, a DC link current connector and management, and a voltage controller. Further, the motor controllers 920 may include fault management circuitry, a processor configured to selectively adjust one or more parameters, and a harmonic analyzer to determine harmonics of the system. Other embodiments are also possible.

In general, complex real systems can be difficult to completely and formally optimize in the field, particularly when unknown variables, such as for example, fuel quality, well pressure and subtle electromechanical changes due to temperature, are constantly changing. The plurality of processing circuits can be configured to continuously make judiciously chosen small changes (variations) on controllable variables and to monitor the effect on relevant observable variables to continuously tune the system performance at each of the processing circuits. The general method of variation is well established and known in the art. In the integrated electric hydraulic fracturing system at various parts of the subsystems and levels in the distributed controller hierarchy, the energy, rate of change of energy, and critical limits of certain measurable parameters are characterized and updated in multi-variable look-up tables maintained by the controllers about the components, considering the states and modes of operation, to coordinate output in the context of reserve capacity. Knowledge of nearby or operationally interrelated controllers reserve capacity estimations, states, modes, and critical limits may be incorporated in optimization cost functions in certain embodiments.

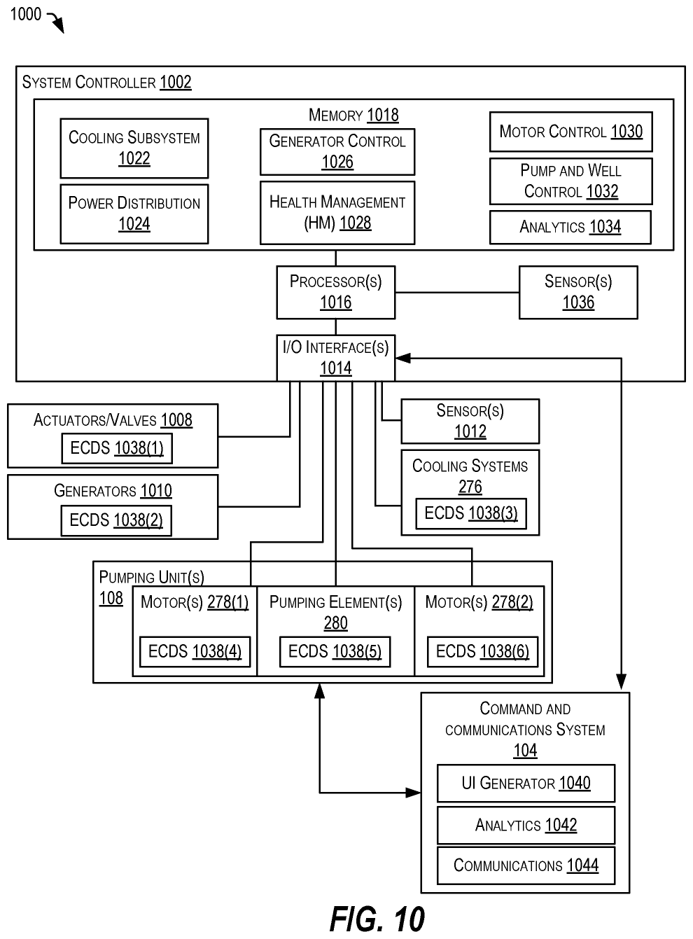

It should be appreciated that the system controller 902 may be distributed across a plurality of components or may be integrated (in total) within each of a plurality of components of the system 900. One possible implementation of a system controller 902 is described below with respect to FIG. 10.

FIG. 10 depicts a block diagram of an integrated electric hydraulic fracturing system 1000, which may include all of the elements of the systems of FIGS. 1-9 and which may include a system controller 902, in accordance with certain embodiments of the present disclosure. The system 1000 may include a system controller 902 coupled to the pumping units 108, which may include one or more pumping elements 280 and one or more motors 278. In some embodiments, each motor 278 may include a pair of electric motors coupled to a rotating shaft or axle, to which the pumping elements 280 may be coupled.

The system controller 902 may also be coupled to one or more actuators/valves 1008, one or more generators 1010, one or more cooling systems 276, and one or more sensors 1012. The system controller 902, the actuators/valves 1008, the one or more cooling systems 276, and the one or more sensors 1012 may be stand-alone devices or may be integrated within the pumping unit 108, depending on the implementation.

The system controller 902 may include one or more input/output (I/O) interfaces 1014, which may be configured to communicate with the actuators/valves 1008, the one or more generators 1010, the one or more cooling systems 276, the one or more sensors 1012, the motors 278, and the pumping elements 108. In some embodiments, the I/O interface 1014 may include an Ethernet connection, a universal serial bus (USB) connection, a controller area network (CAN) connection, a wireless (radio frequency) communications interface, another type of communications interface, or any combination thereof. In some embodiments, the I/O interface 1014 may also communicate with (send data to and receive data, including commands, instructions, and data from) the command and communications system 104.

The system controller 902 may one or more processors 1016 coupled to the I/O interface 1014. The processors 1016 may also be coupled to a memory 1018 and to one or more sensors 1036. The memory 1018 may be configured to store data and to store instructions that, when executed, may cause the one or more processors 1016 to manage operation of the system 1000.

The memory 1018 may include cooling subsystem instructions 1022 that, when executed, may cause the one or more processors 1016 to send signals to a particular motor controller 920 to control operation of pumps 922 and fans 924 (in FIG. 9). The memory 1018 may include power distribution instructions 1024 that, when executed, may cause the one or more processors 1016 to sends signals to power interface circuitry, such as fast disconnect circuitry 904 and monitoring devices 906 in FIG. 9.

The memory 1018 may also include generator control instructions 1026 that, when executed, may cause the one or more processors 1016 to send signals to one or more generators 1010, which may be field generators configured to power the system. The memory 1018 may also include health management instructions 1028 that, when executed, may cause the one or more processors 1016 to control operation of one or more of the components of the system 1000. It should be understood that the health management (HM) components of the system 1000 may be distributed across the various components, and may be implemented based on the response of each component to given set of sensor data and system parameters. The components (electronic control devices 1038 (ECDs)) may include processing circuits and instructions (programmable or hard-coded) that may cause the processing circuits to monitor sensor signals, determine state information, determine event information, and act on the information. In some implementations, the ECDs 1038 may include solenoids, circuit elements, actuators, sensors, and other components that may be configured to determine parameters of various components and may automatically adjust current flow, valve positions, and so on, in order to adjust operation of the system 1000.

In the illustrated example, the ECDs 1038 can include one or more ECDs 1038(1) associated with the actuators/valves 1008; ECDs 1038(2) associated with one or more generators 1010; ECDs 1038(3) associated with the cooling systems 276; ECDs 1038(4) associated with one or more motors 278(1); ECDs 1038(5) associated with the pumping elements 280; other ECDs 1038, or any combination thereof. The pumping unit 108 may include one or more motors 276(2) with associated ECDs 1038(6). In some implementations, the motors 276 may include ECDs 1038, which may include a plurality of processing circuits, including processing circuits associated with each wedge and associated stator coils of the motor 276 as well as processing circuits associated with the motor 276 as a whole. Further, the pumping elements 280 may include ECDs 1038(5) including processing circuits associated with each valve or piston, with each block of pistons, with the pump as a whole, or any combination thereof.

The memory 918 may further include motor instructions that, when executed, cause the one or more processors 1016 to send signals to the motor controllers 920 in FIG. 9. The memory 1018 may also include pump and well control instructions 1032 that, when executed, may cause the one or more processors 1016 to determine pressures, temperatures, and other parameters associated with the well and to send signals to fluid end controllers 930 in FIG. 9. Further, the memory 1018 may include analytics 1034 that, when executed, may cause the one or more processors 1016 to process data from the sensors 1036, the sensors 1012, the actuators/valves 1008, and the cooling systems 276, and to generate control signals within the limits of available power from the generators to selectively adjust operating parameters.

The system 1000 may further include the command and communications system 104. The command and communications system 104 may include a computing device including a processor and a memory, which may store data and instructions that may be accessible to the processor. The command and communications system 104 may include user interface (UI) instructions 1040 that may cause the processor to generate a graphical interface accessible by a user or operator to review data and optionally to provide control signals that may be configured to control one or more parameters of the pump system 1000.

The command and communications system 104 may further include analytics instructions 1042 that, when executed, may cause the processor to analyze data received from the one or more sensors, the generator, and the operating state of the pump system 1000. The analytics instructions 1042 may cause the processor to determine adjustments to operating parameters for the pump system 1000. Other embodiments are also possible.

The command and communications system 104 may also include communications instructions 944 that, when executed, may cause the processor to generate alerts or reports based on the analytics, based on sensed data, or based on other parameters or elements. In one possible example, the analytics 942 may cause the processor to determine early indications of failure or fault conditions, and to generate an alert that may warn an operator/user. The alert may be presented within a graphical interface or may be sent as a text message, an email, a voice alert, an alarm, a visual indicator, or any combination thereof. Other embodiments are also possible.

In general, the systems described above in conjunction with FIGS. 1-9 may be configured to monitor parameters, analyze the parameters, and control operation of individual components, such as coils, pumps, valves, actuators, and so on associated with the system. In some embodiments, during a steady-state operating mode, the processing circuits may continuously monitor and adjust parameters of the system to provide a variational method, which can be used to continuously and automatically tune complex real systems behavior, similar to digital simulation sensitivity analysis for optimizing complex system initial designs.

Complex real systems can be difficult to completely and formally optimize in the field when unknown variables, such as for example, fuel quality, well pressure, and subtle electromechanical changes due to temperature, are constantly changing. The processing circuits may continuously make judiciously chosen small changes (variations) on particular controllable variables and may continuously monitor the effect on relevant observable variables. This particular controllable may then be moved in small steps towards a more optimal direction.

For the overall system, the fundamental controllables may include turbine fuel and air input flow, alternator field DC current, motor coil average current, frequency and phase with respect to rotor position, and so on. In some embodiments, the relative phase between coils may be fixed by the number of coils for highest efficiency, but may be slightly modified to minimize vibration and noise. In some embodiments, the pump may have few controllable inputs except changing RPM, closing or opening valves, bypassing or disconnecting discrete cylinders, or isolating the fluid-end or ends entirely.

In some embodiments, the fundamental observables of the system may include turbine RPM and torque, alternator output voltage and current, motor torque and RPM, and pump flow and pressure. In the variational tuning method, a rough and stable desired power operation point for the turbine RPM, alternator voltage, motor RPM, and pump flow may be experimentally found and stored in a look up table for a given well pressure and flow rate. It should be noted that frack fluid flow and well pressure can be readily observed, and the related system input can be the power in the form of fuel flow.

Given that the alternator and motor are very efficient and that the pump efficiency is relatively constant in the short term, the first variables to optimize may include the turbine fuel and air flow since the turbine is at best in the low forty percent efficiency range. For a given motor power, the air-fuel mixture can be varied over a few seconds, and the alternator output power can be measured easily. The optimum air/fuel operating point for the prevailing conditions including temperature elevation, humidity and fuel flow/heat rate can then be automatically found in less than a minute or so by making small adjustments.

The most efficient turbine power point may be at a higher RPM due to atmospheric and altitude conditions, which would be, at a lower alternator field current, for the same alternator/motor DC bus voltage. It can be readily deduced that the alternator field may also need to be varied, over 10 s of seconds or so, to find the optimum combination of fuel/air and rpm for a given power. At optimum efficiency, the system power flow can be proportional to fuel flow, alternator current times voltage, motor RPM times torque, and pump flow times pressure. Only in an integrated MVDC frack fleet system can efficiency be fully optimized because the integrated system can have control over all the key variables. This is not true with an AC system as the turbine, diesel, and alternator RPM are all fixed due to the fixed 60 Hz line frequency.

Even though the electric motor and drive electronics may be comparably much more efficient than the prime mover, the motor coil currents need to be optimized so as to minimize the losses in the IGBT, windings and magnets. This is a much more time intensive optimization, as the relevant observables are the coil, magnet and IGBT cold plate temperature rises have much slower time constants. For example the IGBT switching frequency, current phase and harmonic current might be varied over 10 s of minutes to minimize a weighted function of the various temperature losses. Most motor temperature rises will increase with coil current, harmonic distortion and switching frequency.

For a given maximum safe temperature rise, optimizing the coil current wave form will permit to optimize maximum available motor torque, or efficiency, or modified as needed to compensate for partial or complete failure of an associated coil or power electronic component. In the preceding examples, the continuous estimation of relevant energy, reserve capacity, response and transfer rates, and critical limits, with layered communication and cost function optimization including dynamic multi-variable lookup tables are central to the distributed control and machine health management system that results in higher efficiency, increased peak power, higher reliability and longer life.

With respect to the health management system, the system may include a plurality of processing circuits and devices. The advent of small rugged and inexpensive digital storage drives makes it possible to monitor every system temperature, flow, pressure, strain, vibration, current, voltage, RPM, and position that can be easily measured. Each data point can be constantly measured, logged and evaluated for out of bounds abnormalities. Some of the measurements can be used to directly and continuously control a process, such as currents for the coils. Other measurements can be used to more slowly and indirectly optimize motor efficiency such as cold plate temperature.

Many of the measurements, such as oil temperatures, may directly affect cooling fan RPM through lower level analog, discrete or digital control loops and motor drives. Some measurements like vibration, turbine input fuel composition, turbine output gas composition are more complex, and may be used to analyze and optimize the integrated frack system.

Continuous and automated analysis of turbine input fuel composition and output gas composition can be used to optimize the turbine operation for short term fuel economy and emissions, and long term maintenance cost. Further, continuous and automated analysis of turbine, alternator, motor, pump oil will be used for automated oil service maintenance scheduling. Such analysis may further be used to steer the alternator and pump RPM away from deleterious resonances. Further, continuous and automated analysis of frack fluid composition, flow, and well head pressure can be compared and adapted to optimize the frack process schedule.

Basic modes that lock certain variables or prioritize certain relationships may be available for simple robust operation, despite suboptimal efficiency, for testing, calibration, and in the event of unforeseen failures that require direct operator intervention. Displays of limits that constrain the available system capacity can be identified for the user as an ongoing built-in self-test based on data logging, trend analysis, and exception reporting.

Data histories can be available per user specification and for maintenance and diagnostic purposes. Data can be used to modify parameters, cost functions, variational ranges, warning levels, and limits, with reporting and appropriate authorization requests to the user and maintenance personnel. In some implementations, the data may also be used to influence evolutions of the system, and further augment the operational characteristics of future fracturing operations.

Although the present invention has been described with reference to preferred embodiments, workers skilled in the art will recognize that changes may be made in form and detail without departing from the scope of the invention.

What is claimed is:

1. A system comprising:
one or more interfaces coupled to a plurality of subsystems, each subsystem including a plurality of components and including one or more control elements;
a processor; and
a memory storing data and processor-executable instructions to cause the processor to:
receive data from each of the one or more control elements;
determine reserve capacities of each of the plurality of components and of each of the plurality of subsystems;
determine an overall reserve capacity based on the reserve capacities; and
selectively control a first component of the plurality of components by sending a control signal to a first control element of the one or more control elements that is associated with the first component.

2. The system of claim 1, wherein:
the plurality of subsystems includes a first subsystem;
the first subsystem includes a first set of control elements of the one or more control elements, the first set of control elements including a first control element and a second control element;
each control element includes one or more sensors to measure one or more parameters of at least one component of the plurality of components; and
the first control element communicatively coupled to the second control element to communicate data associated with the one or more parameters.

3. The system of claim 2, wherein the first control element communicates data associated with the one or more parameters to the processor.

4. The system of claim 1, wherein the plurality of subsystems comprises:
a turbine power unit configured to generate a medium voltage direct current power supply; and
a set of the one or more control elements to control operation of one or more components of the turbine power unit, determine a reserve capacity of the turbine power unit, and communicate data related to the reserve capacity to the processor.

5. The system of claim 1, wherein the plurality of subsystems comprises:
one or more pumping units, each pumping unit including:
an input to receive a fluid at a first pressure;
an output to provide the fluid at a second pressure that is higher than the first pressure;
a plurality of electric motors to rotate a shaft; and
one or more pumping units coupled to the shaft, the one or more pumping units to draw the fluid from the input and to drive the fluid through a plurality of fluid ends to the output; and
a set of the one or more control elements to determine first reserve capacities of each of the plurality of electric motors and second reserve capacities of each of the one or more pumping units, the set to communicate data related to the first reserve capacities and the second reserve capacities to the processor.

6. The system of claim 1, further comprising:
a high pressure fluid conduit;
a coupling mechanism coupled to a well; and
a plurality of sensors including a first sensor coupled to the high pressure fluid conduit and a second sensor coupled to the well.

7. The system of claim 6, wherein the processor-executable instructions cause the processor to:
determine a measured pressure at the well;
compare the measured pressure to a fracture pressure to predict a change in operating conditions when a difference between the measured pressure and the fracture pressure is less than a threshold amount; and
selectively control one or more of the plurality of subsystems in response to the predicted change.

8. The system of claim 1, wherein the processor-executable instructions cause the processor to:
predict a change in operating conditions of a first subsystem of the plurality of subsystems; and
selectively alter operation of a second subsystem of the plurality of subsystems in response to predicting the change.

9. The system of claim 8, wherein:
the first subsystem comprises a pumping unit;
the second subsystem comprises a cooling subsystem; and
the processor causes the cooling subsystem to increase circulation of a cooling fluid to draw heat from one or more components of the pumping unit and from one or more components of a third subsystem in response to the predicted change.

10. The system of claim 9, wherein:
the third subsystem comprises a power generation unit; and
the processor-executable instructions cause the processor to:
increase power generation of the power generation unit after increasing circulation of the cooling fluid; and
subsequently increase a motor speed associated with the pumping unit.

11. A system comprising:
a plurality of subsystems; each subsystem including:
a plurality of components; and
a plurality of control elements to determine parameters of the plurality of components and to independently control one or more of the plurality of components in response to determining the parameters;
a control system including:
one or more interfaces coupled to the plurality of control elements;
a processor; and
a memory storing data and processor-executable instructions to cause the processor to:
receive data from the plurality of control elements;
determine an overall reserve capacity based on the reserve capacities; and
selectively control a first component of the plurality of components by sending a control signal to a first control element of the plurality of control elements that is associated with the first component.

12. The system of claim 11, wherein:
the plurality of subsystems includes a first subsystem;
the first subsystem includes a first set of control elements of the one or more control elements, the first set of control elements including a first control element and a second control element;
each control element includes one or more sensors to measure one or more parameters of at least one component of the plurality of components; and
the first control element communicatively coupled to the second control element to communicate data associated with the one or more parameters.

13. The system of claim 11, wherein the plurality of subsystems comprises:
a turbine power unit configured to generate a medium voltage direct current power supply; and
a set of the plurality of control elements to control operation of one or more of the plurality of components of the turbine power unit, determine a reserve capacity of the turbine power unit, and communicate data related to the reserve capacity to the processor.

14. The system of claim 11, wherein the plurality of subsystems comprises:
one or more pumping units, each pumping unit including:
an input to receive a fluid at a first pressure;
an output to provide the fluid at a second pressure that is higher than the first pressure;
a plurality of electric motors to rotate a shaft; and
one or more pumping units coupled to the shaft, the one or more pumping units to draw the fluid from the input and to drive the fluid through a plurality of fluid ends to the output; and
a set of the plurality of control elements to determine first reserve capacities of each of the plurality of electric motors and second reserve capacities of each of the one or more pumping units, the set to communicate data related to the first reserve capacities and the second reserve capacities to the processor.

15. The system of claim 11, further comprising:
a high pressure fluid conduit;
a coupling mechanism coupled to a well;
a plurality of sensors including a first sensor coupled to the high pressure fluid conduit and a second sensor coupled to the well; and
wherein the processor-executable instructions cause the processor to:
determine a measured pressure at one or more locations at or in the well;
compare the measured pressure to a fracture pressure to predict a change in operating conditions when a difference between the measured pressure and the fracture pressure is less than a threshold amount; and
selectively control one or more of the plurality of subsystems in a pre-determined sequence in response to the predicted change.

16. The system of claim 11, wherein the processor-executable instructions cause the processor to:
predict a change in operating conditions of a pumping unit of the plurality of subsystems based on a predicted change in pressure;
selectively alter operation of a cooling subsystem of the plurality of subsystems in response to predicting the change by increasing circulation of a cooling fluid to draw heat from one or more components of the pumping unit and from one or more components of a power generation unit;
after altering operation of the cooling system, increase power generation of the power generation unit; and
subsequently increase a motor speed associated with the pumping unit.

17. A system comprising:
one or more interfaces coupled to a plurality of subsystems, each subsystem including a plurality of components and including one or more control elements;
a processor; and
a memory storing data and processor-executable instructions to cause the processor to:
receive data from each of the plurality of subsystems, the received data including temperature data, charge data, momentum data, magnetic field data, fluid pressure data, and gas pressure data;
determine a reserve capacity of each of the plurality of subsystems based on component ratings of components of each of the subsystems and based on the received data; and
selectively send control signals to the one or more control elements to selectively alter performance of the plurality of subsystems based on the determined reserve capacity.

18. The system of claim 17, wherein the processor-executable instructions cause the processor to:
determine first information including energy content, total capacity, energy transfer rate, response rate, and critical limits of each of the plurality of components and of the plurality of subsystems;
determine second information related to interactions of the plurality of components and the plurality of subsystems with a surrounding environment;
determine third information including component responses to various fault management conditions, operational modes, and operational states;
determine the reserve capacity of each of the plurality of subsystems and of an overall system based on the first information, the second information, the third information, and the received data; and
update multi-variable lookup tables based on the determined reserve capacity.

19. The system of claim 17, wherein the processor-executable instructions cause the processor to:
determine limits of each of the plurality of components, the determined limits include temperature, stress, voltage, and cumulative effects on such limits based on component fatigue, partial discharge, contamination, corrosion, and other measurable forces including voltage, temperature, current, pressure, tension, stress, and strain;
communicate the determined limits to the one or more control elements.

20. The system of claim 17, wherein the processor-executable instructions cause the processor to send one or more control signals to the one or more control elements to change states or modes of the plurality of components to alter the reserve capacity of one of the plurality of components.
